(19) United States
(12) Patent Application Publication
(10) Pub. No.: US 2014/0141346 A1
(43) Pub. Date: May 22, 2014

(54) METHOD FOR PRODUCING HYDROGEN PEROXIDE, KIT FOR PRODUCING HYDROGEN PEROXIDE, AND FUEL BATTERY

(71) Applicants: Shunichi Fukuzumi, Suita-shi (JP); Tomoyoshi Suenobu, Suita-shi (JP); Satoshi Kato, Suita-shi (JP); Dachao Hong, Suita-shi (JP)

(72) Inventors: Shunichi Fukuzumi, Suita-shi (JP); Tomoyoshi Suenobu, Suita-shi (JP); Satoshi Kato, Suita-shi (JP); Dachao Hong, Suita-shi (JP)

(73) Assignee: OSAKA UNIVERSITY, Suita-shi, Osaka (JP)

(21) Appl. No.: 14/129,001

(22) PCT Filed: Jun. 25, 2012
(86) PCT No.: PCT/JP2012/066191

§ 371 Date: Dec. 23, 2013

(30) Foreign Application Priority Data
Jun. 25, 2011 (JP) 2011-141280

(51) Int. Cl. B01J 19/12; H01M 8/06; B01J 31/22

(52) U.S. Cl. CPC B01J 19/127; B01J 31/2295; H01M 8/0606
USPC 429/421; 502/150; 204/157.5

(57) ABSTRACT

The present invention provides a method and a kit for producing hydrogen peroxide, capable of producing hydrogen peroxide at low cost. The present invention further provides a fuel battery capable of utilizing hydrogen peroxide as a low-cost fuel. The method for producing hydrogen peroxide of the present invention includes a hydrogen peroxide generation step of irradiating a reaction system containing water, a water oxidation catalyst, a transition metal complex, and oxygen (O₂) with light to generate hydrogen peroxide. The kit of the present invention includes the transition metal complex and the water oxidation catalyst that are used in the method for producing hydrogen peroxide of the present invention. The fuel battery of the present invention includes a fuel container and a fuel battery cell, and the fuel container contains the transition metal complex and the water oxidation catalyst that are used in the method for producing hydrogen peroxide of the present invention.

### TECHNICAL FIELD

The present invention relates to a method for producing hydrogen peroxide, a kit for producing hydrogen peroxide, and a fuel battery.

### BACKGROUND ART

Hydrogen peroxide is a compound that is really useful for various applications such as an industrial application and an application for experimental work. The industrial application includes various applications such as applications in pulp bleaching of paper manufacturing, an effluent treatment, and cleaning of semiconductors, for example. Hydrogen peroxide can be decomposed into water and oxygen after use. Therefore, it is considered that unlike a chlorine bleach, hydrogen peroxide does not generate toxic substances and thus has minimal environmental impact. Thus, in recent years, there has been a growing need for hydrogen peroxide. Moreover, as is well known, water solution of hydrogen peroxide is used as the trade name of Oxydol or Oxyful in sterilization and thus is really important for use in medicine and medical use.

Various studies of using hydrogen peroxide as, for example, a fuel have been conducted. Walter-Antrieb has been known as an engine using hydrogen peroxide as a fuel, for example. Walter-Antrieb is a general term for heat engines utilizing water vapor and oxygen generated when high-concentration hydrogen peroxide is decomposed. Walter-Antrieb had been developed by Hellmuth Walter mainly for military purposes from 1933 toward the end of World War II. Walter-Antrieb did not require oxygen for combustion to be supplied from the outside and was thus used as an underwater power for submarines in U-boats and rocket fighters in World War II. After World War II, a liquid-fuel rocket using liquid oxygen as an oxidant became mainstream in the space field, and a nuclear submarine became mainstream as a submarine. Thus, Walter-Antrieb has not been used much. However, Walter-Antrieb has the characteristics of having a relatively simple system configuration and a significant power and thus often has been attempted to be applied in a specific field. For example, a rocket belt developed by an engineer named Moore in Bell Aircraft Corporation in the United States is a flying device for individual use in which a rocket engine and a fuel tank are integrated into a back pack, and a pilot can fly by carrying the back pack on his back. This flying device directly jets a mixed gas of oxygen and water vapor by a low-temperature Walther rocket system, and a pilot can fly by controlling a reaction of the jet. As an example of an actual use of this flying device, a demonstration flight piloted by Bill Suitor on the opening of the Olympics in Los Angeles in 1984 is especially famous, for example. Moreover, as another example of an actual use of the fuel engine using hydrogen peroxide, the fuel engine was used for propelling in experiments of a magnetically-elevated railroad developed by Messerschmitt Bolkow Blohm in 1974, and the speed reached 401.3 km/h, for example.

Even though hydrogen peroxide is a really useful substance as described above, the application thereof is limited because of high production costs. For example, even though hydrogen peroxide is really useful as a fuel as described above, hydrogen peroxide has not been widely popularized because of the high costs. Moreover, for example, a chemical synthesis reaction using hydrogen peroxide includes many important reactions such as vinyl polymerization and the like. However, because of the high cost of hydrogen peroxide, a reaction that has been industrially put into practical use is limited to a synthesis of cyclohexananone oxyme and the like, and the share thereof remains low.

As a method for producing hydrogen peroxide, a method utilizing an auto-oxidation reaction of an anthracene derivative, using hydrogen (H₂) and oxygen (O₂) as raw materials has been used (hereinafter referred to as “anthraquinone method”). Specifically, for example, 2-ethylanthrahydroquinone or 2-amylanthrahydroquinone is dissolved in a solvent, and the solvent is mixed with oxygen in air. Thus, the anthrahydroquinone derivative is oxidized, and an anthraquinone derivative and hydrogen peroxide are generated. Then, the generated hydrogen peroxide is extracted and separated using ion-exchange water. After the extraction separation, an organic solvent contained in the hydrogen peroxide is removed, and further, the hydrogen peroxide is distilled under reduced pressure to obtain high-concentration water solution of hydrogen peroxide (30% to 60% by mass). The anthraquinone derivative generated at the same time as the generation of the hydrogen peroxide is subjected to hydrogen reduction using a nickel catalyst or a palladium catalyst to return to an anthrahydroquinone derivative, and the anthrahydroquinone derivative is reused again as a catalyst. In this anthraquinone method, in some cases, a side chain is oxidized at the time of oxidation of the anthrahydroquinone derivative, and an aromatic ring is reduced at the time of reduction of the anthraquinone derivative. Thus, an appropriate reprocessing treatment is required. Moreover, using hydrogen as a raw material is also a part of the reason for the high production costs.

As an increase in industrial usage of hydrogen peroxide, research and development on a low-cost production method and a low-cost purification method as a substitute for the anthraquinone method has been performed. For example, there is a method for directly synthesizing hydrogen peroxide from hydrogen (H₂) and oxygen (O₂) in an acidic solution using Pd/C or Au—Pd/TiO₂ as a catalyst. However, this method involves an issue of safety. Moreover, since hydrogen is used as a raw material as in the anthraquinone method, this method is not a radical solution to the high production costs. As described above, the problem of the high cost of hydrogen peroxide has not been solved yet.

On the other hand, as a water oxidation catalyst, catalysts described in the following Non-Patent Documents 1 and 2 have been known, for example. The water oxidation catalyst can oxidize water by being present with an oxidant in water. However, even though the water oxidation catalyst is an important substance that is academically really interesting, the industrial application value thereof has not been found. This is because a product obtained by oxidizing water is oxygen (O₂) that is universally present in air, and thus, the cost thereof does not meet the need. Even if water is oxidized with a water oxidation catalyst, hydrogen peroxide has not been able to be obtained. The hydrogen peroxide is, as mentioned above, produced using hydrogen and oxygen as raw materials, and thus, the production cost thereof is high.

### PRIOR ART DOCUMENTS

### Non-Patent Document

Non-Patent Document 1: Y. V. Geletii, B. Botar, P. Koegerler, D. A. Hillesheim, D. G. Musaev, C. L. Hill, Angew. Chem., hit. Ed. 2008, 47, 3896-3899
Non-Patent Document 2: Andrea Sartorel, Mauro Carraro, Gianfranco Scorrano, Rita De Zorzi, Silvan Geremia, Neal D. McDaniel, Stefan Bernhard, and Marcella Bonchio, J. AM. CHEM. SOC. 2008, 130, 5006-5007

### SUMMARY OF INVENTION

### Problem to be Solved by the Invention

The present invention is intended to provide a method and a kit for producing hydrogen peroxide, capable of producing hydrogen peroxide at low cost. The present invention is intended further to provide a fuel battery capable of utilizing hydrogen peroxide as a low-cost fuel.

### Means for Solving Problem

In order to achieve the aforementioned object, the method for producing hydrogen peroxide according to the present invention includes: a hydrogen peroxide generation step of irradiating a reaction system containing water, a water oxidation catalyst, a transition metal complex, and oxygen (O₂) with light to generate hydrogen peroxide.

The kit according to the present invention is a kit for producing hydrogen peroxide, including: the transition metal complex and the water oxidation catalyst that are used in the method for producing hydrogen peroxide according to the present invention.

The fuel battery according to the present invention includes: a fuel container; and a fuel battery cell, and the fuel container contains the transition metal complex and the water oxidation catalyst that are used in the method for producing hydrogen peroxide according to the present invention.

### Effects of the Invention

According to the method or the kit for producing hydrogen peroxide according to the present invention, hydrogen peroxide can be produced at low cost. Moreover, the fuel container in the fuel battery according to the present invention contains the transition metal complex and the water oxidation catalyst that are used in the method for producing hydrogen peroxide according to the present invention. Thus, hydrogen peroxide can be utilized as a low-cost fuel.

### BRIEF DESCRIPTION OF DRAWINGS

FIG. 1 is a schematic view showing an example of a configuration of a fuel battery according to the present invention.

FIG. 2 shows visible absorption spectra of TiO(tpypH₄)⁴⁺ and TiO₂(tpypH₄)⁴⁺.

FIG. 3 is a graph showing a result of a quantitative determination of hydrogen peroxide in Example 1.

FIG. 4 is a graph showing a result of a quantitative determination of hydrogen peroxide in Example 2.

FIG. 5 is a schematic view representing a reaction mechanism as an example and a graph showing a reaction result in Reference Example 1.

FIG. 6 is a graph showing reaction results in the case where the concentration of sulfuric acid is changed in Reference Example 1.

FIG. 7 shows a schematic view representing a reaction mechanism as an example and a graph showing reaction results in Reference Example 2.

FIG. 8 shows a schematic view representing a reaction mechanism as an example and a graph showing reaction results in Example 3.

FIG. 9A shows a schematic view representing a reaction mechanism as an example and a graph showing reaction results in Example 4.

FIG. 9B shows another graph showing reaction results in Example 4.

FIG. 10A shows a schematic view representing a reaction mechanism in Example 5 as an example and graphs showing reaction results in Example 5 and Reference Example 3.

FIG. 10B is another graph showing reaction results in Example 5

FIG. 10C is another graph showing reaction results in Reference Example 3.

FIG. 11 shows measurement results of iridium oxide by thermogravimetric analysis/differential thermal analysis (thermal gravity-differential thermal simultaneous analysis, TG/DTA) and dynamic light scattering (DLS) as examples.

FIGS. 12A and 12B are graphs showing measurement results obtained by subjecting Rb₈K₂[{Ru₄O₄(OH)₂(H₂O)₄}(γ-SiW₁₀O₃₆)₂].25H₂O to cyclic voltammetry.

FIG. 13 shows graphs showing measurement results obtained by subjecting iridium oxide to X-ray photoelectron spectroscopy as examples.

FIG. 14 shows other graphs showing measurement results by the same X-ray photoelectron spectroscopy as in Example 13.

FIG. 15 shows a schematic view representing a reaction mechanism as an example and a graph showing reaction results in Reference Example 4.

FIG. 16 shows a schematic view representing a reaction mechanism and graphs showing reaction results in Example 6.

FIG. 17 shows a schematic view representing a reaction mechanism and a graph showing reaction results in Example 7.

FIG. 18 shows schematic views representing reaction mechanisms and graphs showing reaction results in Reference Example 5 and Example 8.

FIG. 19 shows schematic views representing reaction mechanisms and graphs showing reaction results in Examples 9 and 10.

FIG. 20 shows schematic views representing reaction mechanisms and graphs showing reaction results in Examples 11 and 12.

FIG. 21 is a graph showing reaction results in Example 13.

FIG. 22 is another graph showing reaction results in Example 13.

### DESCRIPTION OF EMBODIMENTS

As mentioned above, hydrogen peroxide is produced using hydrogen and oxygen as raw material, and a method capable of producing hydrogen peroxide at low cost has not been found. Moreover, even if water is oxidized with a water oxidation catalyst, a resultant product is oxygen that is universally present in air, and the industrial application value of the water oxidation catalyst has not been found.

However, the inventors of the present invention conducted earnest studies and found that hydrogen peroxide can be produced at low cost using a water oxidation catalyst in combination with a transition metal complex and using water as a raw material and reached the present invention.

A reaction mechanism of generation of hydrogen peroxide in the production method according to the present invention is yet to be clarified. However, the following scheme 1 is assumed, for example. The following scheme 1 and the description thereof however, merely show an example of an assumable reaction mechanism schematically and do not limit the present invention.

In the following scheme 1, Cat. represents a water oxidation catalyst, and [M¹] represents a transition metal atom in a transition metal complex. In the present invention, “atom” may be ion unless otherwise mentioned.

In the following scheme 1, the water oxidation catalyst Cat. oxidizes water to generate oxygen O₂. On the other hand, a transition metal atom [M¹] in the transition metal complex becomes a transition metal atom [M¹]* in the excited state by being irradiated with light. This transition metal atom [M¹]* in the excited state reduces dissolved oxygen gas O₂ in water to generate hydrogen peroxide H₂O₂ and is oxidized to [M¹]⁺. The dissolved oxygen gas O₂ may be, for example, oxygen dissolved in water (reaction system) in advance or oxygen generated by oxidation of water by the water oxidation catalyst Cat. A proton source of the hydrogen peroxide H₂O₂ is, for example, considered to be water or a proton dissolved in water.

It is assumed that the water oxidation catalyst Cat. repeatedly changes its state between the oxidized state and the reduced state, although it is not shown. That is, the water oxidation catalyst Cat. in the oxidized state oxidizes water to generate oxygen O₂, and the water oxidation catalyst itself is reduced by water and thus is put into the reduced state. The water oxidation catalyst Cat. in the reduced state reduces the transition metal atom [M¹]⁺ to [M¹], and the water oxidation catalyst itself is returned to be in the oxidized state. As described above, the transition metal complex containing a transition metal atom [M¹] and the water oxidation catalyst Cat. function as catalysts, and hydrogen peroxide H₂O₂ can be produced from water H₂O and oxygen O₂.

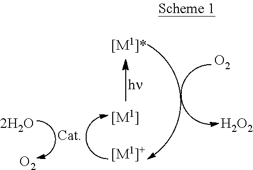

The transition metal atom is prone to be in a plurality of states having different oxidation numbers. Moreover, a ligand coordinates to the transition metal atom to form a complex, and thus, the excited state of the transition metal atom is stabilized. The inventors of the present invention focused on these properties of the transition metal complex and found that the transition metal complex can be used, in combination with the water oxidation catalyst, in the method for producing hydrogen peroxide according to the present invention.

In the scheme 1, the oxidation number (electric charge) of [M¹] is not limited to 0 and can be any number. The oxidation number (electric charge) of [M¹]⁺ also is not limited to +1 as long as it is the oxidation number (electric charge) of [M¹] or more. In the scheme 1, a ratio of the amount of each reactive substance and the amount of a product (including a water oxidation catalyst and a transition metal atom) does not always reflect a stoichiometric ratio.

When the transition metal complex is a divalent ruthenium complex, and the water oxidation catalyst is iridium oxide, the scheme 1 can be represented by the following scheme 2, for example. The following scheme 2, however, is an example of an assumable reaction mechanism and does not limit the present invention. In the following scheme 2, Rut represents a ruthenium atom (divalent ion) in a divalent ruthenium complex, and Rum represents a ruthenium atom (trivalent ion) in a trivalent ruthenium complex generated by oxidizing the divalent ruthenium complex. Moreover, IrOₓ represents iridium oxide. X is any positive number. IrOₓ may contain only iridium with a single oxidation number or may be a mixture of a plurality of iridium oxides with different oxidation numbers. That is, IrOₓ may be, for example, at least one selected from the group consisting of IrO, Ir₂O₃, IrO₂, IrO₃, and IrO₄. The divalent ruthenium complex is not particularly limited and can be, for example, a divalent ruthenium complex represented by chemical formula (2) or (4) described below.

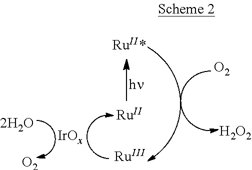

In general, a product of an oxidation reaction of water with a water oxidation catalyst is, as mentioned above, oxygen (O₂) that is universally present in air, and thus, an industrial application value of the water oxidation catalyst has not been found. However, according to the present invention, hydrogen peroxide can be produced at really low cost using water as a raw material without using an expensive raw material such as hydrogen (H₂), and thus, there is a great industrial application value. Moreover, in the method for producing hydrogen peroxide according to the present invention, light is used as an energy source. Thus, the method is simple and can contribute to lower cost. For example, the method for producing hydrogen peroxide according to the present invention can be performed simply at low cost by using visible light (sunlight or the like) that can be utilized easily as an energy source or by performing a reaction by only irradiation with light without using a heat source.

Moreover, in a conventional oxidation reaction of water with a water oxidation catalyst, a reaction has finished after completely running out of an oxidant used in combination. Thus, far more product has not been able to be obtained after the finish of the reaction. However, in the present invention, the transition metal complex used in combination with a water oxidation catalyst functions as both of an oxidant and a reductant as mentioned above. Thus, the transition metal complex can return to the original state. That is, not only the water oxidation catalyst but also the transition metal complex functions as a catalyst. Thus, in theory, a reaction cycle continues indefinitely, and hydrogen peroxide is generated continuously, as long as water as a raw material is present. This, however, is just a theory. The cycle number in an actual reaction in the method for producing hydrogen peroxide according to the present invention generally has a limitation because of a deterioration of a catalyst and the like as in a normal catalystic reaction.

Reaction mechanisms of the method for producing hydrogen peroxide according to the present invention are described above with reference to the schemes 1 and 2. The schemes 1 and 2, however, are mere examples of an assumable reaction mechanism as mentioned above, and the present invention is not at all limited by the description above.

The present invention is described in further detail below.

[<1> Transition Metal Complex]

The transition metal complex used in the hydrogen peroxide production method according to the present invention (hereinafter also referred to as the hydrogen peroxide production method according to the present invention) is not particularly limited and may be, for example, a complex obtained by coordinating an organic ligand with a transition metal atom (forming a coordinate bond between a transition metal atom and an organic ligand). The coordinate bond is not particularly limited and may be, for example, a covalent bond, an ion bond, or a bond having properties of the both bonds. In the organic ligand, an atom that coordinates (form a coordinate bond) with the transition metal atom is not particularly limited and may be, for example, a carbon atom or any of other atoms except carbon. Moreover, the transition metal atom is not limited to a neutral atom and may be an ion, and the ion has any electron charge (oxidation number).

The transition metal complex is preferably a complex obtained by coordinating an aromatic ligand with a transition metal atom. The metal complex is more preferably a complex represented by the following chemical formula (1).

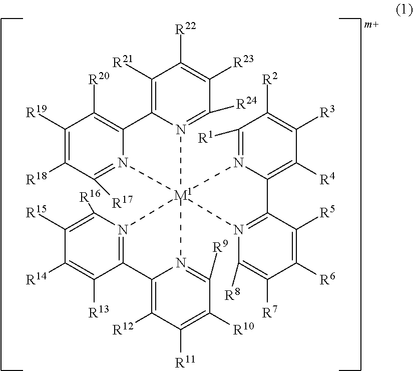

In the chemical formula (1), M¹ is a transition metal atom, R¹ to R²⁴ are each independently a hydrogen atom or any substituent, or R⁴ and R⁵ may together form a —CH═CH—, that is, R⁴ and R⁵ may, together with a bipyridine ring to which R⁴ and R⁵ are bound, form a phenanthroline ring, where Hs in the —CH═CH— may be each independently replaced by a substituent, R¹² and R¹³ may together form a —CH═CH—, that is, R¹² and R¹³ may, together with a bipyridine ring to which R¹² and R¹³ are bound, form a phenanthroline ring, where Hs in the —CH═CH— may be each independently replaced by a substituent, and R²⁰ and R²¹ may together form a —CH═CH—, that is, R²⁰ and R²¹ may, together with a bipyridine ring to which R²⁰ and R²¹ are bound, form a phenanthroline ring, where Hs in the —CH═CH— may be each independently replaced by a substituent, and m is a positive integer, 0, or a negative integer.

The number of transition metal atoms in the transition metal complex may be 1 or more, and in the case of plural transition metal atoms, they may be identical to or different from each other. The transition metal atom is preferably at least one selected from the group consisting of ruthenium, osmium, iron, manganese, chromium, cobalt, iridium, rhodium, and platinum. In the case where transition metal complex is a complex represented by the chemical formula (1), M¹ is preferably ruthenium, osmium, iron, manganese, chromium, cobalt, iridium, rhodium, or platinum. The oxidation number (electric charge) of each transition metal atom is not particularly limited and is, for example, in the range from +1 to +6. The oxidation number (electric charge) is preferably +2 or +3 in the case or ruthenium, preferably in the range from +2 to +6 in the case of osmium, preferably in the range from +2 to +5 in the case of iron, preferably in the range from +2 to +5 in the case of manganese, preferably in the range from +2 to +6 in the case of chromium, and preferably in the range from +1 to +5 in the case of cobalt, preferably in the range from +1 to +5 in the case of iridium, preferably in the range from +1 to +5 in the case of rhodium, preferably in the range from +1 to +5 in the case of platinum. It is particularly preferred that M¹ in the chemical formula (1) is ruthenium.

In the chemical formula (1), R¹ to R²⁴ are preferably each independently a hydrogen atom, an alkyl group, an aryl group, a nitro group, a halogen group, a sulfonic acid group (sulfo group), an amino group, an alkylamino group, a carboxylic acid group (carboxy group), a hydroxy group, an alkoxy group, a perfluoroalkyl group, an acyl group, an alkanoyl group, an acyloxy group, or an alkanoyloxy group. R⁴ and R⁵ may together form a —CH═CH—, that is, R⁴ and R⁵ may, together with a bipyridine ring to which R⁴ and R⁵ are bound, form a phenanthroline ring, where Hs in the —CH═CH— may be each independently replaced by an alkyl group, an aryl group, a nitro group, a halogen group, a sulfonic acid group (sulfo group), an amino group, an alkylamino group, a carboxylic acid group (carboxy group), a hydroxy group, an alkoxy group, a perfluoroalkyl group, an acyl group, an alkanoyl group, an acyloxy group, or an alkanoyloxy group. R¹² and R¹³ may together form a —CH═CH—, that is, R¹² and R¹³ may, together with a bipyridine ring to which R¹² and R¹³ are bound, form a phenanthroline ring, where Hs in the —CH═CH— may be each independently replaced by an alkyl group, an aryl group, a nitro group, a halogen group, a sulfonic acid group (sulfo group), an amino group, an alkylamino group, a carboxylic acid group (carboxy group), a hydroxy group, an alkoxy group, a perfluoroalkyl group, an acyl group, an alkanoyl group, an acyloxy group, or an alkanoyloxy group. R²⁰ and R²¹ may together form a —CH═CH—, that is, R²⁰ and R²¹ may, together with a bipyridine ring to which R²⁰ and R²¹ are bound, form a phenanthroline ring, where Hs in the —CH═CH— may be each independently replaced by an alkyl group, an aryl group, a nitro group, a halogen group, a sulfonic acid group (sulfo group), an amino group, an alkylamino group, a carboxylic acid group (carboxy group), a hydroxy group, an alkoxy group, a perfluoroalkyl group, an acyl group, an alkanoyl group, an acyloxy group, or an alkanoyloxy group.

In the chemical formula (1), R¹ to R²⁴ are preferably each independently a hydrogen atom, a straight-chain or branched alkyl group with a carbon number from 1 to 6, a phenyl group, a nitro group, a halogen group, a sulfonic acid group (sulfo group), an amino group, a straight-chain or branched alkylamino group with a carbon number from 1 to 6, a carboxylic acid group (carboxy group), a hydroxy group, an alkoxy group, a perfluoroalkyl group, a straight-chain or branched alkanoyl group with a carbon number from 1 to 6, or a straight-chain or branched alkanoyloxy group with a carbon number from 1 to 6. R⁴ and R⁵ may together form a —CH═CH—, that is, R⁴ and R⁵ may, together with a bipyridine ring to which R⁴ and R⁵ are bound, form a phenanthroline ring, where Hs of the —CH═CH— may be each independently replaced by a straight-chain or branched alkyl group with a carbon number from 1 to 6, a phenyl group, a nitro group, a halogen group, a sulfonic acid group (sulfo group), an amino group, a straight-chain or branched alkylamino group with a carbon number from 1 to 6, a carboxylic acid group (carboxy group), a hydroxy group, an alkoxy group, a perfluoroalkyl group, a straight-chain or branched alkanoyl group with a carbon number from 1 to 6, or a straight-chain or branched alkanoyloxy group with a carbon number from 1 to 6. R¹² and R¹³ may together form a —CH═CH—, that is, R¹² and R¹³ may, together with a bipyridine ring to which R¹² and R¹³ are bound, form a phenanthroline ring, where Hs in the —CH═CH— may be each independently replaced by a straight-chain or branched alkyl group with a carbon number from 1 to 6, a phenyl group, a nitro group, a halogen group, a sulfonic acid group (sulfo group), an amino group, a straight-chain or branched alkylamino group with a carbon number from 1 to 6, a carboxylic acid group (carboxy group), a hydroxy group, an alkoxy group, a perfluoroalkyl group, a straight-chain or branched alkanoyl group with a carbon number from 1 to 6, or a straight-chain or branched alkanoyloxy group with a carbon number from 1 to 6. R²⁰ and R²¹ may together form a —CH═CH—, that is, R²⁰ and R²¹ may, together with a bipyridine ring to which R²⁰ and R²¹ are bound, form a phenanthroline ring, where Hs in the —CH═CH— may be each independently replaced by a straight-chain or branched alkyl group with a carbon number from 1 to 6, a phenyl group, a nitro group, a halogen group, a sulfonic acid group (sulfo group), an amino group, a straight-chain or branched alkylamino group with a carbon number from 1 to 6, a carboxylic acid group (carboxy group), a hydroxy group, an alkoxy group, a perfluoroalkyl group, a straight-chain or branched alkanoyl group with a carbon number from 1 to 6, or a straight-chain or branched alkanoyloxy group with a carbon number from 1 to 6.

In the chemical formula (1), all of R¹ to R²⁴ may be hydrogen atoms, for example. Furthermore, in the chemical formula (1), m is preferably in the range from +1 to +5, more preferably +2, +3, or +4.

The complex represented by the chemical formula (1) is more preferably a complex represented by the following chemical formula (2) or (3),

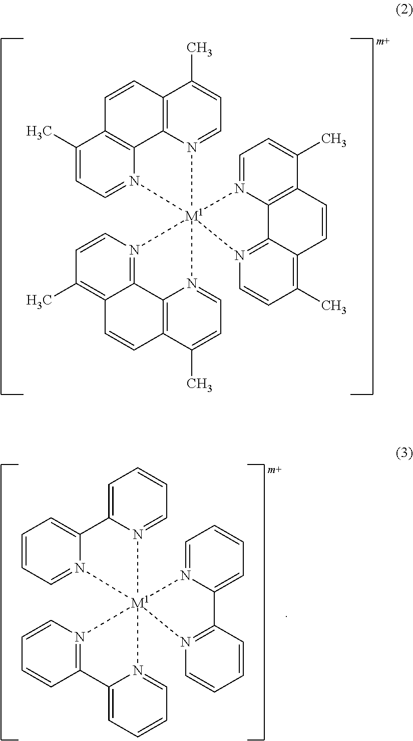

In the chemical formulae (2) and (3), M¹ and m are the same as those in the chemical formula (1).

The complex represented by the chemical formula (1) is yet more preferably a complex represented by the following chemical formula (4) or (5) and is particularly preferably a complex represented by the following chemical formula (4),

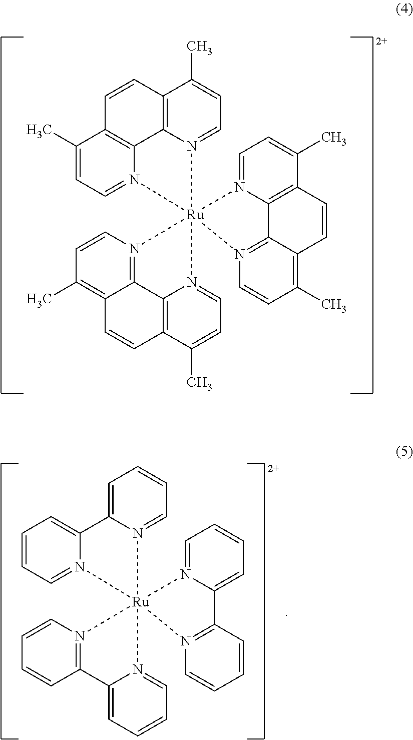

The transition metal complex represented by the formula (1) is not limited by the formula (4) or (5) and can be any complex.

When there are isomers such as a tautomer and a stereoisomer (e.g., a geometrical isomer, a conformational isomer, and an optical isomer) of the transition metal complex, any of the isomers can be used in the present invention. A salt of the transition metal complex may be an acid addition salt or a base addition salt. Moreover, an acid forming the acid addition salt may be an inorganic acid or an organic acid, and a base forming the base addition salt may be an inorganic base or an organic base. The inorganic acid is not particularly limited, and examples thereof include sulfuric acid, phosphoric acid, hydrofluoric acid, hydrochloric acid, hydrobromic acid, hydroiodic acid, hypofluorous acid, hypochlorous acid, hypobromous acid, hypoiodous acid, fluorous acid, chlorous acid, bromous acid, iodous acid, fluorine acid, chloric acid, bromic acid, iodine acid, perfluoric acid, perchloric acid, perbromic acid, and periodic acid. The organic acid is not particularly limited, and examples thereof include p-toluene sulfonic acid, methanesulfonic acid, oxalic acid, p-bromobenzenesulfonic acid, carbonic acid, succinic acid, citric acid, benzoic acid, and acetic acid. The inorganic base is not particularly limited, and examples thereof include ammonium hydroxide, alkali metal hydroxide, alkali earth metal hydroxide, carbonate, and hydrogencarbonate, and specific examples thereof include sodium hydroxide, potassium hydroxide, potassium carbonate, sodium carbonate, sodium bicarbonate, potassium bicarbonate, calcium hydroxide, and calcium carbonate. The organic base also is not particularly limited, and examples thereof include ethanolamine, triethylamine, and tris(hydroxymethyl)aminomethane. The method for producing each of these salts also is not particularly limited, and each salt can be produced by a method in which the above-described acid or base is added to the electron donor-electron acceptor linking molecule as appropriate by a conventionally known method or the like, for example.

The absorption band of the transition metal complex is not particularly limited and preferably has an absorption band in a visible light region. When the transition metal complex has an absorption band in a visible light region, it becomes possible to excite using visible light, and sunlight can be utilized as an energy source, for example. With this configuration, the transition metal complex is applicable to a solar battery, and the like.

In the present invention, the alkyl group is not particularly limited, and examples thereof include a methyl group, an ethyl group, a n-propyl group, an isopropyl group, a n-butyl group, an isobutyl group, a sec-butyl group, a tert-butyl group, a pentyl group, a hexyl group, a heptyl group, an octyl group, a nonyl group, a decyl group, an undecyl group, a dodecyl group, a tridecyl group, a tetradecyl group, a pentadecyl group, a hexadecyl group, a heptadecyl group, an octadecyl group, a nonadecyl group, an icosyl group. The same applies to a group (an alkylamino group, an alkoxy group, or the like) having an alkyl group in the structure thereof. The perfluoroalkyl group is not particularly limited, and examples thereof include perfluoroalkyl groups derived from a methyl group, an ethyl group, an n-propyl group, an isopropyl group, a n-butyl group, an isobutyl group, a sec-butyl group, a tert-butyl group, a pentyl group, a hexyl group, a heptyl group, an octyl group, a nonyl group, a decyl group, an undecyl group, a dodecyl group, a tridecyl group, a tetradecyl group, a pentadecyl group, a hexadecyl group, a heptadecyl group, an octadecyl group, a nonadecyl group, and an icosyl group. The same applies to a group (a perfluoroalkylsulfonyl group, a perfluoroacyl group, or the like) having a perfluoroalkyl group in the structure thereof. In the present invention, the acyl group is not particularly limited, and examples thereof include a formyl group, an acetyl group, a propionyl group, an isobutyryl group, a valeryl group, an isovaleryl group, a pivaloyl group, a hexanoyl group, a cyclohexanoyl group, a benzoyl group, and an ethoxycarbonyl group. The same applies to a group (an acyloxy group, an alkanoyloxy group, or the like) having an acyl group in the structure thereof. Moreover, in the present invention, the carbon number of an acyl group includes the carbonyl carbon number, and for example, an alkanoyl group (acyl group) with a carbon number of 1 represents a formyl group. Furthermore, in the present invention, “halogen” indicates any halogen element, and examples thereof include fluorine, chlorine, bromine, and iodine. When there are isomers of a substituent, any of the isomers can be used. For example, “a propyl group” may be any of an n-propyl group and an isopropyl group.

[<1-2> Method for Producing Transition Metal Complex]

In the present invention, the transition metal complex can be a commercially available product or can be produced (synthesized) as appropriate. When the transition metal complex is produced, a method for producing the transition metal complex is not particularly limited, and the transition metal complex can be produced as appropriate by, or with reference to, a conventionally known production method, for example. For example, the transition metal complex can be produced by dissolving a transition metal salt and a ligand in a solvent such as water or alcohol. In the case of the transition metal complex represented by any of the chemical formulae (2) to (5) (specifically the chemical formula (4) or (5)), the transition metal complex can be produced with reference to a method described in Reference Document 1 below, for example.
[Reference Document 1]
Kotkar, D.; Ghosh, P. K. Inorg. Chem. 1987, 26, 208. or Young, R. C.; Meyer, T. J.; Whitten, D. G. J. Am. Chem. Soc. 1976, 98, 286.

The produced transition metal complex may be subjected to an anion exchange treatment, if necessary. The method of the anion exchange treatment is not particularly limited, and any method can be used as appropriate. Examples of a substance that can be used in the anion exchange treatment include the various organic acids and inorganic acids, and they may be used alone or in a combination of two or more of them. Reactive substances, solvents, and the like other than these substances may or may not be used as appropriate if necessary.

[<2> Water Oxidation Catalyst]

In the present invention, the water oxidation catalyst is not particularly limited and is preferably a transition metal oxide or an oxo complex. Examples of the oxo complex include an oxo complex of ruthenium, an oxo complex of manganese, and an oxo complex of iridium. The water oxidation catalyst is, for example, more preferably at least one selected from the group consisting of an oxo complex of ruthenium, an oxo complex of manganese, an oxo complex of iridium, an oxo complex of iron, indium oxide, ruthenium oxide, iridium oxide, tungsten oxide, and vanadic acid bismuth. The water oxidation catalyst may be, for example, at least one selected from the group consisting of IrO, Ir₂O₃, IrO₂, IrO₃, IrO₄, WO₃, BiVO₄, Rb₈K₂[{Ru₄O₄(OH)₂(H₂O)₄}(γ-SiW₁₀O₃₆)₂], Cs₁₀[Ru₄(μ-O)₄(μ-OH)₂(H₂O)₄(γ-SiW₁₀O₃₆)₂], Li₁₀[Ru₄(μ-O)₄(μ-OH)₂(H₂O)₄(γ-SiW₁₀O₃₆)₂], Li₁₀[Ru₄(μ-O)₄(μ-OH)₂(H₂O)₄(γ-SiW₁₀O₃₆)₂], Na₁₀[{Ru₄O₄(OH)₂(H₂O)₄}(γ-SiW₁₀O₃₆)₂], K₁₀[{Ru₄O₄(OH)₂(H₂O)₄}(γ-SiW₁₀O₃₆)₂], Rb₁₀[{Ru₄O₄(OH)₂(H₂O)₄}(γ-SiW₁₀O₃₆)₂], and Cs₁₀[Ru₄(μ-O)₄(μ-OH)₂(H₂O)₄(γ-SiW₁₀O₃₆)₂].

The water oxidation catalyst is particularly preferably iridium oxide. It is preferred that iridium oxide is easily suspended in water and tends not to generate a precipitate because an oxidation reaction of water easily occurs at the time for irradiation with light. More specifically, preferably at least 1 mg, more preferably at least 1.5 mg, still more preferably at least 3.0 mg, even more preferably at least 12 mg, yet more preferably at least 50 mg, yet still more preferably at least 80 mg, yet even more preferably at least 100 mg, more preferably at least 200 mg, particularly preferably at least 300 mg of the iridium oxide can be suspended in 100 mL of water at 25° C. For the same reason, the average particle size of the iridium oxide, measured by dynamic light scattering is preferably from 1 to 10,000 nm, more preferably from 1 to 1,000 nm, yet more preferably from 5 to 500 nm, particularly preferably from 10 to 500 nm. For the same reason, the specific surface area of the iridium oxide, by BET for surface area measurement, is preferably 0.8 m²/g or more, more preferably 5 m²/g or more, yet more preferably 10 m²/g or more, particularly preferably 20 m²/g or more. The upper limit of the specific surface area is not particularly limited and is, for example, 50 m²/g or less or 30 m²/g or less. For the same reason, the change in weight of the iridium oxide, measured by thermogravimetry/differential thermal analysis at from 0° C. to 600° C. is preferably 70% or less, more preferably 40% or less, yet more preferably 30% or less. The absolute value of the amount of change in electrical potential measured by differential thermal analysis at from 0° C. to 600° C. is preferably 20 μV or less, more preferably 10 μV or less, yet more preferably 5 μV or less. Further, examples of the valence of iridium in the iridium oxide include zelovalence, monovalence, bivalence, trivalence, tetravalence, pentavalence, and hexavalence. Iridium atoms in the iridium oxide may be composed of iridium atoms with one kind of valence or contain a plurality of kinds of atoms having different valences and preferably contain trivalent iridium atoms. Furthermore, binding energy derived from the is orbit of oxygen in the iridium oxide, measured by X-ray photoelectron spectroscopy is preferably from 528 to 536 eV (electron volt), more preferably from 530 to 534 eV, yet more preferably from 531 to 533 eV. A method for producing the iridium oxide is not particularly limited and can be obtained by heating H₂IrCl₆.6H₂O in a aqueous NaOH solution. This production method is described below.

The water oxidation catalyst preferably has properties of being easily suspended and being difficult to be dissolved in water, for example. This is because when the water oxidation catalyst has such properties, the water oxidation catalyst can be easily separated from a reaction system by merely filtrating and thus is easily handled. Examples of the water oxidation catalyst which is easily suspended and is difficult to be dissolved in water include iridium oxide, tungsten oxide, and vanadic acid bismuth. For the same reason, the transition metal complex may also be a complex that is easily suspended and is difficult to be dissolved in water.

[<2-2> Method for Producing Water Oxidation Catalyst]

In the present invention, a method for producing the water oxidation catalyst is not particularly limited. For example, in the case of iridium oxide, iridium oxide may be produced by heating H₂IrCl₆.6H₂O in an aqueous NaOH solution as mentioned above. The concentration of the H₂IrCl₆.6H₂O is not particularly limited and is, for example, from 1 to 300 mmol/L, preferably from 10 to 80 mmol/L, more preferably from 20 to 50 mmol/L. The concentration of NaOH also is not particularly limited and is, for example, from 0.001 to 10 mmol/L, preferably from 0.05 to 1 mmol/L, more preferably from 0.1 to 0.5 mmol/L. The heating temperature also is not particularly limited and is, for example, 40° C. or more, preferably 80° C. or more, particularly preferably around a boiling point of water (about 100° C. under ordinary pressure). For example, according to a conventional method, reflux using a condenser or the like may be performed. The heating time also is not particularly limited and is, for example, from 2 to 100 minutes, preferably from 10 to 50 minutes, more preferably from 20 to 40 minutes. For example, in addition to or as a substitute for H²IrCl₆.6H₂O, other iridium salts such as K₂IrCl₆ and the like may be used. Moreover, for example, in addition to or as a substitute for NaOH, other alkali metal hydroxides such as KOH and the like or other inorganic bases may be used. A method for purifying the produced iridium oxide also is not particularly limited, and for example, a precipitate of the iridium oxide may be obtained by filtration, washed with water if necessary, and thereafter dried.

The above-described method for producing iridium oxide can be performed with reference to the examples described below or the Reference Document 2 below, for example.
[Reference Document 2]
Hoertz, P. G.; Kim, Y. I.; Youngblood, W. J.; Mallouk, T. E. J. Phys. Chem. B 2007, 111 (24), 6845.

For example, when the water oxidation catalyst is a metal complex, iridium oxide can be produced by a method in which an aqueous metal ion solution and an aqueous ligand solution are mixed to cause the metal ion and the ligand to react with each other or the like. After mixing the aqueous solutions, the resultant mixture may be heated if necessary. Examples of such a method for producing a water oxidation catalyst include a method for producing Rb₈K₂[{Ru₄O₄(OH)₂(H₂O)₄}(γ-SiW₁₀O₃₆)₂], described in the Supporting Information (available from http://www.wiley-vch.de/contents/jc_{—}2002/2008/z705652_s.ndf as of the filing date of the present application) of the Non-Patent Document 1 (Y. V. Geletii, B. Botar, P. Koegerler, D. A. Hillesheim, D. G. Musaev, C. L. Hill, Angew. Chem., Int. Ed. 2008, 47, 3896-3899) and methods for producing Cs₁₀[Ru₄(μ-O)₄(μ-OH)₂(H₂O)₄(γ-SiW₁₀O₃₆)₂] and Li₁₀[Ru₄(μ-O)₄(μ-OH)₂(H₂O)₄(γ-SiW₁₀O₃₆)₂] described in the Supporting Information (available from http://pubs.acs.org/doi/suppl/10.1021/ja077837f/suppl_file/ja077837f-file004.pdf as of the filing date of the present application) of the Non-Patent Document 2 (Andrea Sartorel, Mauro Camaro, Gianfranco Scorrano, Rita De Zorzi, Silvan Geremia, Neal D. McDaniel, Stefan Bernhard, and Marcella Bonchio, J. AM. CHEM. SOC. 2008, 130, 5006-5007). Specific experimental procedures of these methods are shown below.

(Method for producing Rb₈K₂[{Ru₄O₄(OH)₂(H₂O)₄}(γ-SiW₁₀O₃₆)₂] (Non-Patent Document 1))

(1) Tris(2,2′-bipyridyl)dichlororuthenium(II) hexahydrate (Ru(bpy)₃²⁺)Cl₂ was purchased from Aldrich. Tris(2,2′-bipyridyl)perchlororuthenium(III) salt (Ru(bpy)₃³⁺)Cl₃ was obtained by oxidizing Ru(bpy)₃²⁺ with PbO₂ in 0.5M H₂SO₄ and then adding concentrated HClO₄ to cause a precipitate to be generated (V. Y. Shafirovich, V. V. Strelets, Bulletin of the Academy of Sciences of the USSR, Division of Chemical Sciences 1980, 7. and V. Y. Shafirovich, N. K. Khannanov, V. V. Strelets, Nouveau Journal de Chimie 1980, 4, 81.). The obtained (Ru(bpy)₃³⁺)Cl₃ was dried under reduced pressure, stored in a sealed vial at −18° C., and used up within 1 to 2 weeks.

(2) Potassium γ-deca tungsto silicate K₄[γ-SiW₁₀O₃₆].12H₂O was synthesized and purified according to a method in the document (A. Teze, G. Herve, in Inorganic Syntheses, Vol. 27 (Ed.: A. P. Ginsberg), John Wiley and Sons, New York 1990, pp. 85.) and infrared spectral values thereof were compared with those in the document to identify. The synthesis and the purification were performed as follows. That is, first, sodium tungstate (182 g, 0.55 mol) was dissolved in 300 mL of water. 4M HCl (165 mL) was added drop by drop and mixed into this aqueous solution thus obtained over 10 minutes while stirring the aqueous solution. A solution obtained by dissolving sodium metasilicate (11 g, 50 mmol) in 100 mL of water was further poured into this mixed solution, and 4M HCl was then added to adjust the pH to 5 to 6. This solution thus obtained with the pH was stood still for 100 minutes, and thereafter KCl (90 g) was added to the solution. Thus, a white precipitate was generated. This precipitate was obtained by filtration and was again dissolved in 850 mL of water. Impurities were removed by filtration, and KCl (80 g) was again added to the solution. Then, a generated precipitate was again obtained by filtration. Thus, K₈[β₂-SiW₁₁O₃₉].14H₂O (60 to 80 g) was obtained (yield: 37% to 50%). This K₈[β₂-SiW₁₁O₃₉].14H₂O (15 g, 5 mmol) was dissolved in 150 mL of water, and the mixture thus obtained was filtered with celite to remove impurities. A 2M aqueous potassium carbonate solution was added to this filtrate thus obtained immediately after the filtration to adjust the pH to 9.1. A 2M aqueous potassium carbonate solution was continuously dropped into this aqueous solution thus obtained to maintain the pH 9.1 for 16 minutes. After the 16 minutes, KCl (40 g) was added to the aqueous solution. Thus, a white precipitate was generated. This precipitate was obtained by filtration and washed with a 1M aqueous KCl solution. Thus, an intended product K₈[γ-SiW₁₀O₃₆]12H₂O (to 10 g) was obtained (yield: 70%). The pH was measured (tracked) as appropriate using a pH meter.

(3) Synthesis of Rb₈K₂[{Ru₄O₄(OH)₂(H₂O)₄}(γ-SiW₁₀O₃₆)₂].25H₂O

Freshly synthesized K₈[γ-SiW₁₀O₃₆]12H₂O (4.00 g, 1.33 mmol) was dissolved in 65 mL of water, and a solid sample (0.60 g, 2.67 mmol) of RuCl₃.H₂O was expeditiously added to the solution thus obtained. The color of the solution was changed to brown immediately after the addition of the RuCl₃.H₂O, and the pH of the solution was reduced to 2.6. Further, 6M HCl was added to this solution to adjust the pH to 1.6. This solution was then stirred for 5 minutes, and thereafter, to the solution, a solution obtained by dissolving RbCl (2.4 g, 20 mmol) in 10 to 15 mL of water was added bit by bit. The mixture thus obtained was filtered, and a filtrate thus obtained was kept still for 24 hours at room temperature. Thus, a brown plate crystal was deposited. It was confirmed by instrumental analysis that this brown plate crystal was the intended product. The amount of the intended product was 1.8 g (yield: about 40% by weight). Values obtained by the instrumental analysis are shown below.

Elemental analysis values: Calculated values: W 55.14, Ru 6.11, Si 0.84, Rb 10.18, K 1.17; Actual values: W 552, Ru 5.8, Si 0.73, Rb 10.2, K 0.95.

The number of molecules of crystallized water was measured by thermogravimetric analysis (thermogravimetricanalysis, TGA).

IR (KBr pellet; 2000 to 400 cm⁻¹): 1616 (m), 999 (m), 947 (m-s), 914 (s), 874 (s), 802 (vs), 765 (vs), 690 (sh), 630 (sh), 572 (m-s), 542 (ms).

Raman spectrum (in H₂O, c=0.153 mM; le=1064 nm): 1066 (w, br), 968 (w), 871 (w), 798 (w, br), 604 (w), 487 (s), 427 (s, br).

As described above, the infrared (IR) spectrum and the Raman spectrum showed a typical pattern of γ-disubstituted polytungstate. The absorption at 487 cm⁻¹ in the Raman spectrum shows the presence of a Ru—O—Ru bond.

Rb₈K₂[{Ru₄O₄(OH)₂(H₂O)₄}(γ-SiW₁₀O₃₆)₂].25H₂O was unreacted in EPR (X-band, room temperature, saturated aqueous solution). Moreover, in a measurement of magnetic susceptibility (2 to 290 K, 0.1 and 1.0 tesla), Rb₈K₂[{Ru₄O₄(OH)₂(H₂O)₄}(γ-SiW₁₀O₃₆)₂].25H₂O showed a characteristic of diamagnetism (X_{dia/TIP}=−4.2×10⁻⁴ emu mol⁻¹).

The maximum absorption wavelength λₘₐₓ (nm) in an electron absorption spectrum (400 to 900 nm, in H₂O (the concentration c=0.153 mM, the cell length: 0.1 mm)) and the extinction coefficient ε (M⁻¹cm⁻¹) at the λₘₐₓ are as follows.

pH 4.9 (pH was not adjusted): λₘₐₓ=445 nm, extinction constant ε was not quantitatively determined.

Measurement after adjusting pH to 2.5: λₘₐₓ=445 nm, extinction constant ε=2.8×10⁴M⁻¹cm⁻¹

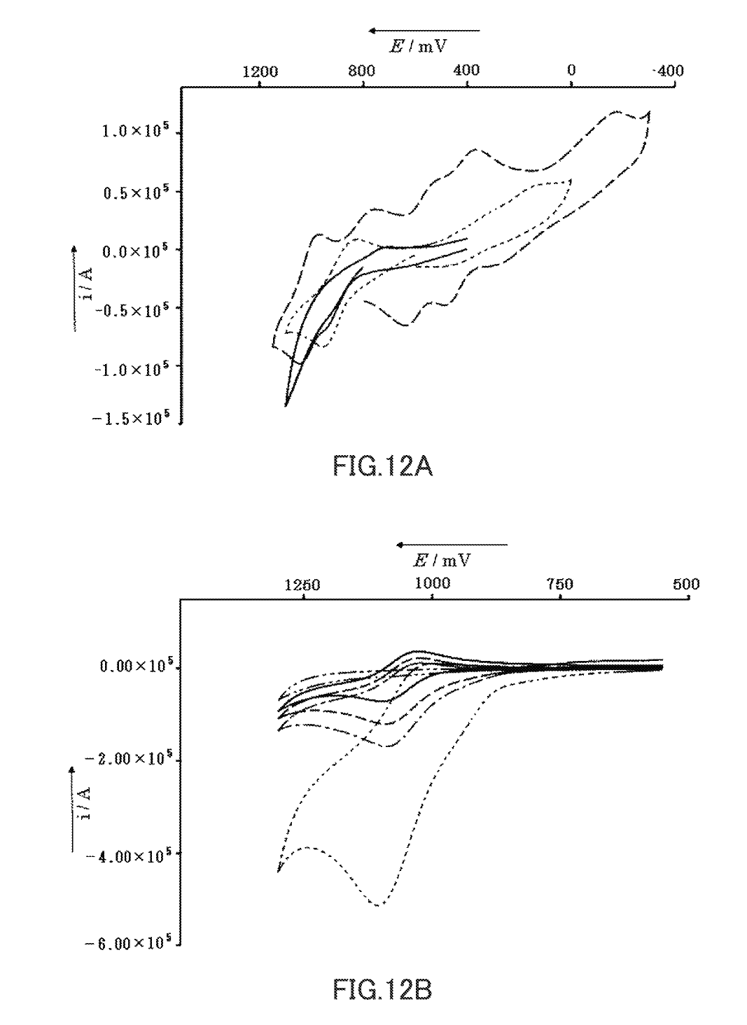

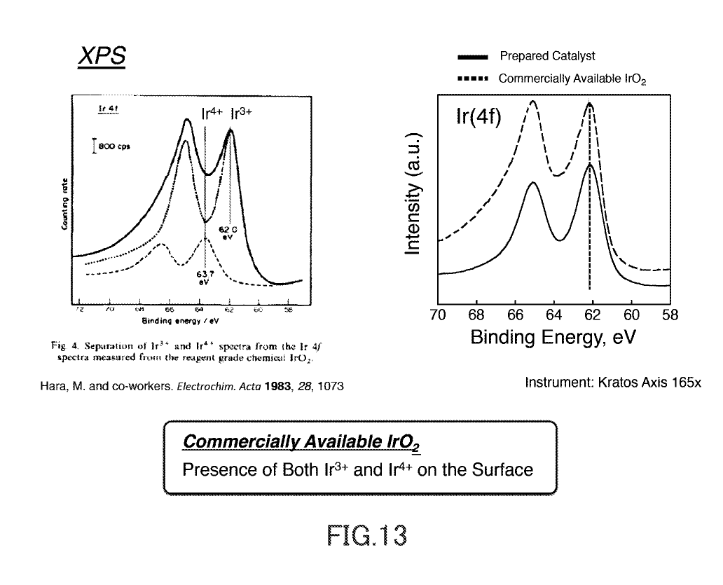

The graphs of FIGS. 12A and 12B show measurement results obtained by subjecting the Rb₈K₂[{Ru₄O₄(OH)₂(H₂O)₄}(γ-SiW₁₀O₃₆)₂].25H₂O to cyclic voltammetry (CV). In FIGS. 12A and 12B, the horizontal axis indicates a voltage (mV), and the vertical axis indicates a current. The measurements in FIGS. 12A and 12B were performed in a solution with a pH 7.0, containing a 0.025M sodium phosphate buffer solution and 0.15M NaCl at a scan rate of 25 mV/s. In FIG. 12A, a solid line indicates measurement values with respect to 0.6 mM Rb₈K₂[{Ru₄O₄(OH)₂(H₂O)₄}(γ-SiW₁₀O₃₆)₂].25H₂O at pH 7.0. A dashed line indicates measurement values with respect to 1 mM Rb₈K₂[{Ru₄O₄(OH)₂(H₂O)₄}(γ-SiW₁₀O₃₆)₂].25H₂O in 0.1M HCl (pH 1.0). A dotted line indicates measurement values with respect to 1 mM Rb₈K₂[{Ru₄O₄(OH)₂(H₂O)₄}(γ-SiW₁₀O₃₆)₂].25H₂O in a 0.4M sodium acetate buffer solution (pH 4.7). The voltage is a value in an Ag/AgCl reference electrode (3 m NaCl). As shown in FIG. 12A, the CV of Rb₈K₂[{Ru₄O₄(OH)₂(H₂O)₄}(γ-SiW₁₀O₃₆)₂].25H₂O had pH dependency. In FIG. 12B, a solid line indicates measurement values in the presence of 1 mM [Ru(bpy)₃]²⁺ without Rb₈K₂[{Ru₄O₄(OH)₂(H₂O)₄}(γ-SiW₁₀O₃₆)₂].25H₂O (concentration: 0). A dashed line indicates measurements values with respect to 0.006 mM Rb₈K₂[{Ru₄O₄(OH)₂(H₂O)₄}(γ-SiW₁₀O₃₆)₂].25H₂O in the presence of 1 mM [Ru(bpy)₃]²⁺. An alternate long and short dash line indicates measurement values with respect to 0.012 mM Rb₈K₂[{Ru₄O₄(OH)₂(H₂O)₄}(γ-SiW₁₀O₃₆)₂].25H₂O in the presence of 1 mM [Ru(bpy)₃]²⁺. A dotted line indicates measurement values with respect to 0.029 mM Rb₈K₂[{Ru₄O₄(OH)₂(H₂O)₄}(γ-SiW₁₀O₃₆)₂].25H₂O in the presence of 1 mM [Ru(bpy)₃]²⁺. An alternate long and two short dashes line indicates measurement values with respect to 0.029 mM Rb₈K₂[{Ru₄O₄(OH)₂(H₂O)₄}(γ-SiW₁₀O₃₆)₂].25H₂O in the absence of [Ru(bpy)₃]²⁺. The measurements in FIG. 12B were performed at pH 7.0.

(Methods for producing Cs₁₀[Ru₄(μ-O)₄(μ-OH)₂(H₂O)₄(γ-SiW₁₀O₃₆)₂] and Li₁₀[Ru₄(μ-O)₄(μ-OH)₂(H₂O)₄(γ-SiW₁₀O₃₆)₂] (Non-Patent Document 2))

### (1) Synthesis of cesium salt Cs₁₀[Ru₄(μ-O)₄(μ-OH)₂(H₂O)₄(γ-SiW₁₀O₃₆)₂]

262 mg (0.359 mmol) of K₄Ru₂OCl₁₀ was dissolved in 30 ml of deionized water. 1 g (0.336 mmol) of K₈γ-SiW₁₀O₃₆-12H₂O was then added to the solution thus obtained. The pH of the obtained dark brown solution was 6.2. This solution was heated for 1 hour at 70° C., and when the pH of the solution became 1.8, the solution was filtered. Then, an excess amount of CsCl (4.4 g, 26.1 mmol) was added to a filtrate. Thus, a precipitate was obtained. Thus precipitate was washed with 2 to 3 mL of cold water three times. Thus, 980 mg (85%) of a cesium salt Cs₁₀[Ru₄(μ-O)₄(μ-OH)₂(H₂O)₄(γ-SiW₁₀O₃₆)₂] was obtained as the intended product.

### (2) Synthesis of lithium salt Li₁₀[Ru₄(μ-O)₄(μ-OH)₂(H₂O)₄(γ-SiW₁₀O₃₆)₂]

The cesium salt Cs₁₀[Ru₄(μ-O)₄(μ-OH)₂(H₂O)₄(γ-SiW₁₀O₃₆)₂] obtained as described above was dissolved in 100 ml of water, the solution thus obtained was caused to pass through a positive ion exchange resin. Thus, 800 mg of the lithium salt Li₁₀[Ru₄(μ-O)₄(μ-OH)₂(H₂O)₄(γ-SiW₁₀O₃₆)₂] was obtained. This aqueous unpurified lithium salt solution was passed into a column using Sephadex (trade name) G-50 as a solid phase, and about 50 mg of the first fraction was removed. Thus, the lithium salt was purified. A ratio of the amount of water and the amount of the solid phase per 1 g of the lithium salt was 5 mL of water: 10 g of the solid phase. A solvent was removed from the eluate. Thus, 700 mg of the purified lithium salt was obtained (yield: 75% by weight). After the intended product was completely eluted, the solid phase in the column remained colored black. It was assumed that this was because some low-molecular weight ruthenium chemical species remained.

Instrumental analysis values of the cesium salt and the lithium salt are shown below.

Elemental analysis values of the crystal of the cesium salt Cs₁₀[Ru₄(μ-O)₄(μ-OH)₂(H₂O)₄(γ-SiW₁₀O₃₆)₂] (values in parentheses indicate calculated values based on Cs₁₀[Ru₄(μ-O)₄(μ-OH)₂(H₂O)₄(γ-SiW₁₀O₃₆)₂]: Cs: 19.20% (19.58%); Ru: 5.93% (5.96%); Si: 0.845% (0.827%); W: 53.75% (54.16%).

When the sample was dried before being subjected to the elemental analysis, 3.85% of the mass was reduced. This reduced mass corresponds to 15 molecules of hydration water of Cs₁₀[Ru₄(μ-O)₄(μ-OH)₂(H₂O)₄(γ-SiW₁₀O₃₆)₂].

FT-IR (KBr, polyoxometalate region) of the cesium salt Cs₁₀[Ru₄(μ-O)₄(μ-OH)₂(H₂O)₄(γ-SiW₁₀O₃₆)₂]: 1002 (w), 950 (m), 915 (s), 880 (s), 799 (s, br), 764 (sh), 707 (sh), 562 (m), 545 (m) cm⁻¹. R Raman spectrum: 483 (s), 804 (w), 870 (m), 950 (m) cm⁻¹.

### UV-Vis spectrum of lithium salt Li₁₀[Ru₄(μ-O)₄(μ-OH)₂(H₂O)₄(γ-SiW₁₀O₃₆)₂]

The UV-Vis spectrum of the lithium salt Li₁₀[Ru₄(μ-O)₄(μ-OH)₂(H₂O)₄(γ-SiW₁₀O₃₆)₂] had pH dependency. That is, in the acidic region, an extinction coefficient ε (M⁻¹cm⁻¹) was increased at the maximum absorption wavelength λₘₐₓ (nm)=443 nm, and log ε=4.57 at the pH of 2.0 or less. It was assumed that this was derived from the d-d transitions in ruthenium. In contrast, in the case where the pH was not adjusted, the absorption at 443 nm was not increased, and a continuous absorption merely was observed. It was assumed that this was derived from a charge transfer band from ruthenium to tungsten. Moreover, it was estimated from a reversible change in the UV-Vis spectrum that pKa=3.62. It was considered that one of aqueous ligands was deprotonated and forms [Ru₄(μ-O)₄(μ-OH)₂(H₂O)₃(OH)(γ-SiW₁₀O₃₂)₂]¹¹⁻.

An aqueous lithium salt Li₁₀[Ru₄(μ-O)₄(μ-OH)₂(H₂O)₄(γ-SiW₁₀O₃₆)₂] solution (10⁻⁵M, pH 5.11) was subjected to a spectrophotometric titration of [Ru₄(μ-O)₄(μ-OH)₂(H₂O)₃(OH)(γ-SiW₁₀O₃₂)₂]¹¹⁻ with an addition of HNO₃ (1M), and absorbance at λ=443 nm was plotted. The result was calculated as pKa=3.62. In the same manner as described above, an aqueous lithium salt Li₁₀[Ru₄(μ-O)₄(μ-OH)₂(H₂O)₄(γ-SiW₁₀O₃₆)₂] ([Ru₄(μ-O)₄(μ-OH)₂(H₂O)₃(OH)(γ-SiW₁₀O₃₂)₂]¹¹⁻) solution (10⁻²M, pH 4.97) was subjected to an acid-base titration with an addition of HNO₃ (1M). It was estimated that pKa=3.7 which showed a good match with the result obtained by the spectrophotometric titration. Moreover, from a ratio of blots between [H⁺] and [HNO₃]/[POM] obtained by the acid-base titration, a stoichiometric relationship of 1:1 was found. In the acid-base titration, [H+] indicates a concentration of the hydrogen ion, [HNO₃] indicates a concentration of the nitric acid, [POM] indicates a concentration of the lithium salt Li₁₀[Ru₄(μ-O)₄(μ-OH)₂(H₂O)₄(γ-SiW₁₀O₃₆)₂] ([Ru₄(μ-O)₄(μ-OH)₂(H₂O)₃(OH)(γ-SiW₁₀O₃₂)₂]¹¹⁻).

ESI-MS of the lithium salt Li₁₀[Ru₄(μ-O)₄(μ-OH)₂(H₂O)₄(γ-SiW₁₀O₃₆)₂] (10⁻³M of the lithium salt, measurement in a solvent of CH₃CN:H₂O:HCOOH=49:50:1): m/z (relative intensity)=1798 (100), [H₉Ru₄Si₂W₂₀O₇₈]³⁻; 1348 (83), [H₈Ru₄Si₂W₂₀O₇₈]⁴⁻. PW₁₂O₄₀³⁻ (m/z=957) was used as a standard substance.

Cyclic voltammetry of lithium salt Li₁₀[Ru₄(μ-O)₄(μ-OH)₂(H₂O)₄(γ-SiW₁₀O₃₆)₂]:

Concentrated H₂SO₄ (10⁻³M) was added to an aqueous lithium salt Li₁₀[Ru₄(μ-O)₄(μ-OH)₂(H₂O)₄(γ-SiW₁₀O₃₆)₂] solution (10⁻³M) to adjust the pH to 0.60, and the solution thus obtained was subjected to a measurement by cyclic voltammetry. A measurement value of a resting electrical potential was 0.72 V (Ag/AgCl reference electrode). Measurement conditions were an initial electrical potential=0.72 V; a switching electrical potential (1)=1.4 V; a switching electrical potential (2)=0 V; a final electrical potential=0.72 V; and a scan rate=100 mVs⁻¹. In the cyclic voltammetry, four anode waves and four cathode waves were shown between +1.4 to −0.0 V (vs Ag/AgCl). Almost reversible four redox couples were observed at E1/2=+1.12, +0.70, +0.53, and +0.29V with peak resolutions ΔEp (=Epa−Epc)=89, 98, 59, and 166 mV. Even when the scanning direction was reversed, the same redox waves were observed.

[<3> Method for Producing Hydrogen Peroxide]

As mentioned above, the hydrogen peroxide production method according to the present invention includes a hydrogen peroxide generation step of irradiating a reaction system containing water, a water oxidation catalyst, a transition metal complex, and oxygen (O₂) with light to generate hydrogen peroxide. Other than this, the hydrogen peroxide production method according to the present invention is not particularly limited and can be performed as follows, for example.

First, a reaction system containing water, a water oxidation catalyst, a transition metal complex, and oxygen (O₂) is prepared. For example, this reaction system preparation step may be performed prior to the hydrogen peroxide generation step, or a part or all of the reaction system preparation step can be performed while performing the hydrogen peroxide generation step (i.e., while irradiating a reaction system with light). As a specific procedure of the reaction system preparation step, for example, a water oxidation catalyst, a transition metal complex, and oxygen (O₂) may be dispersed in water. The form of the dispersion is not particularly limited and may be, for example, dissolution or suspension. In the case of using a substance which is difficult to be dispersed in water, ultrasonic irradiation or the like can be used as appropriate in accordance with a conventional method. In the reaction system, the concentration of the transition metal complex is not particularly limited and is, for example, from 0.0001 to 0.1 mmol/L, preferably from 0.002 to 0.05 mmol/L, particularly preferably from 0.004 to 0.02 mmol/L. Moreover, in the reaction system, the concentration of the water oxidation catalyst is not particularly limited and is, for example, from 0.05 to 10 g/L, preferably from 0.5 to 5 g/L, more preferably from 0.8 to 2 g/L. The concentration of the oxygen (O₂) also is not particularly limited and is preferably a high possible concentration from the viewpoint of reactivity, and it is particularly preferred that the reaction system (water) is saturated with oxygen (O₂).

The reaction system may or may not further contain a substance besides water, a water oxidation catalyst, a transition metal complex, and oxygen (O₂). For example, the reaction system may further contain a pH adjuster from the viewpoint of reactivity described below. Examples of the pH adjuster include basic substances such as sodium hydroxide, potassium hydroxide, sodium hydrogen phosphate, potassium hydrogen phosphate, sodium phosphate, potassium phosphate, and sodium acetate and acidic substances such as hydrochloric acid, sulfuric acid, nitric acid, acetic acid, and phosphoric acid. Furthermore, for example, the water may be in a state of being a pH buffer solution by dissolving a pH buffer agent in water. Examples of the pH buffer solution include a phosphate buffer solution and an acetate buffer solution. The amounts of the pH adjuster to be added and the pH buffer agent to be added are not particularly limited and can be set as appropriate. Oxygen can be reduced with higher reaction efficiency under acidic conditions in many cases, and water can be oxidized with higher reaction efficiency under basic conditions in many cases, although it depends on reaction conditions. Therefore, it is preferred that considering these tendencies, the pH of the reaction system is set as appropriate so as to have higher production efficiency of hydrogen peroxide. From this viewpoint, the pH of the reaction system is, for example, from −2 to 10, preferably from −2 to 8, more preferably from −2 to 7, yet more preferably from −1 to 5, yet further more preferably from −0.5 to 3, yet even more preferably from −0.2 to 3, particularly preferably from −0.2 to 2. In the case where the water oxidation catalyst is iridium oxide, and the transition metal complex is a ruthenium complex, the pH of the reaction system is preferably from −2 to 8, more preferably from −2 to 5, yet more preferably from −1 to 3, particularly preferably from −0.5 to 2.

From the viewpoint of the production efficiency of hydrogen peroxide, the reaction system may further contain Lewis acid. The Lewis acid is preferably a metal ion, more preferably a transition metal ion, yet more preferably a Group 3 metal ion. Examples of the Group 3 metal ion include a scandium ion, an yttrium ion, a lanthanoid ion, and an actinoid ion. The Group 3 metal ion is preferably at least one selected from the group consisting of Sc³⁺, Y³⁺, Lu³⁺, La³⁺, Yb³⁺, Ce³⁺, Yb³⁺, and Sm³⁺, particularly preferably Sc³⁺. In the case where the reaction system contains the metal ion (Lewis acid), the amount of the metal ion (by mole) is not particularly limited and is, for example, from 1 to 50000 times, preferably from 100 to 10000 times, more preferably from 1000 to 10000 times the amount of the transition metal complex (by mole). The Lewis acid (e.g., the metal ion) or a salt thereof may also function as the pH adjuster.

The reaction system may or may not further contain an organic solvent. Examples of the organic solvent include: nitrile such as benzonitrile, acetonitrile, or butyronitrile; a halogenated solvent such as chloroform or dichloromethane; ether such as THF (tetrahydrofuran); amide such as DMF (dimethylformamide); sulfoxide such as DMSO (dimethyl sulfoxide); ketone such as acetone; alcohol such as methanol, and mitromethane. These solvents may be used alone or in a combination of two or more of them. As the solvent, a highly-polar solvent is preferable from the viewpoint of solubility of the transition metal complex, stability of excited state, and the like, and acetonitrile is particularly preferable.

Then, a hydrogen peroxide generation step of irradiating a reaction system containing water, a water oxidation catalyst, a transition metal complex, and oxygen (O₂) with light to generate hydrogen peroxide is performed. As mentioned above, this hydrogen peroxide generation step can be performed while performing the reaction system preparation step or performed after the reaction system preparation step. As a procedure of performing the hydrogen peroxide generation step while performing the reaction system preparation step, oxygen (O₂) may be dissolved in water while irradiating a system containing water, a water oxidation catalyst, and a transition metal complex with light, for example. Irradiation light for the irradiation with light is not particularly limited and is preferably visible light. In order to excite the transition metal complex by visible light, the transition metal complex preferably has an absorption band in a visible light region. The wavelength of visible light with which the transition metal complex is irradiated is, for example, from 400 to 850 nm, more preferably from 410 to 750 nm, yet more preferably from 420 to 650 nm, although it depends on an absorption band of the transition metal complex. In the case where the transition metal complex is a complex represented by the chemical formula (4) or (5), the wavelength of the irradiation light is as mentioned above and is particularly preferably from 420 to 550 nm. In the hydrogen peroxide generation step, the temperature at which the irradiation with light is performed is also not particularly limited and may be, for example, room temperature of about 10° C. to about 30° C.

A light source in the irradiation with light is not particularly limited, and natural light such as sunlight is preferably utilized from the viewpoint of energy saving, for example. Sunlight includes light in a wide wavelength region (specifically, visible light region) and has superior light intensity. Thus, high reaction efficiency can be easily obtained. As a substitute for or in addition to the natural light, light sources such as a xenon lump, a halogen lump, a fluorescent lamp, and a mercury lamp may or may not be used as appropriate. Furthermore, a filter that cuts a wavelength other than a necessary wavelength may or may not be used as appropriate.

While irradiating the reaction system with light, the reaction system may be kept still or stirred. The reaction system may be heated and the like if necessary, and is it preferred that the reaction is performed by only irradiating the reaction system with light without heating and the like because of simplicity. The time for the irradiation with light, light intensity, and the like are not particularly limited and can be set as appropriate.

The reaction mechanism of the hydrogen peroxide generation step is, as mentioned above, represented by the scheme 1 or 2. In the reactions of the schemes 1 and 2, an oxygen molecule O₂ that is a raw material of hydrogen peroxide is not particularly limited and may be, for example, O₂ generated by oxidation of water, O₂ dissolved in water before the reaction, or O₂ in air dissolved in water while stirring the reaction system. As mentioned above, it is particularly preferred that the reaction system (water) is saturated with O₂ in advance from the viewpoint of reaction efficiency.

In the hydrogen peroxide production reaction step, the TON (Turn Over Number) and the TOF (Turn Over Frequency, a turn over number per 1 hour) are not particularly limited, and the highest possible TON and TOF are preferable. The TON is an amount of hydrogen peroxide generated per 1 mole of a catalyst in the entire hydrogen peroxide generation step by mole, and the TOF is a value determined by dividing the TON by time (h) for which the hydrogen peroxide generation step is performed. Further, both of the water oxidation catalyst and the transition metal complex can function as a catalyst, and thus, the TON and the TOF of each of them can be defined. The TON based on the transition metal complex is, for example, 1 or more, preferably 10 or more, more preferably 100 or more, and the upper limit thereof is not particularly limited and is, for example, 10,000 or less. The TOF based on the transition metal complex is, for example, 5 or more, preferably 10 or more, more preferably 50 or more, and the upper limit thereof is not particularly limited and is, for example, 5,000 or less.

The hydrogen peroxide production method according to the present invention can be performed as described above. The hydrogen peroxide production method according to the present invention may further include a hydrogen peroxide purification step of purifying the generated hydrogen peroxide after the hydrogen peroxide generation step, if necessary. By this hydrogen peroxide purification step, hydrogen peroxide or water solution of hydrogen peroxide, being suitable for actual use and having high purity can be obtained. A specific method of the hydrogen peroxide purification step is not particularly limited, and for example, high-concentration water solution of hydrogen peroxide can be obtained by extracting hydrogen peroxide with ion-exchange water and distilling it under reduced pressure.

[<4> Kit for Producing Hydrogen Peroxide]

As mentioned above, the kit for producing hydrogen peroxide according to the present invention includes the transition metal complex and the water oxidation catalyst that are used in the hydrogen peroxide production method according to the present invention. Other than this, the kit according to the present invention is not particularly limited and may or may not further include another component as appropriate besides the water oxidation catalyst. The another component can be, for example, the above-mentioned light source. The kit for producing hydrogen peroxide according to the present invention can be used widely in experimental use, industrial use, and the like by setting its configuration, scale, and the like.

[<5> Fuel Battery]

As mentioned above, the fuel battery according to the present invention includes a fuel container and a fuel battery cell, and the fuel container contains the transition metal complex and the water oxidation catalyst that are used in the hydrogen peroxide production method according to the present invention. Other than this, the fuel battery according to the present invention is not particularly limited and is, for example, as follows.

When the fuel container further contains water and oxygen, hydrogen peroxide can be generated in the fuel container by the hydrogen peroxide production method according to the present invention. The fuel battery cell is not particularly limited and may have a structure including anode and cathode, for example. The fuel battery cell may be integrated into the fuel container, for example. A reaction on the anode-side can be represented by the following mathematical expression [1], for example. A reaction on the cathode-side can be represented by the following mathematical expression [2], for example. An entire reaction including these reactions can be represented by the following mathematical expression [3], for example.

Anode side: H₂O₂/O₂+2H⁺+2e⁻ [1]

Cathode side: H₂O₂+2H⁺+2e⁻/2H₂O [2]

Entire reaction: 2H₂O₂/O₂+2H₂O [3]

The fuel battery according to the present invention may be configured with reference to Reference Document 3 or 4 below, for example,
[Reference Document 3]
Chem. Commun., 2010, 46, 7334-7336

### Reference Example 4

“Protonated iron-phthalocyanine complex used for cathode material of a hydrogen peroxide fuel battery operated under acidic conditions”, Yusuke Yamada, Sho Yoshida, Tatsuhiko Honda and Shunichi Fukuzumi; Energy Environ. Sci., 2011, First published on the web 16 Jun. 2011 (*Electronic Supplementary Information of Reference Example 4 can be downloaded from http://www.rsc.org/suppdata/ee/c1/c1ee01587g/c1ee01587g.pdf as of the filing date of the present application.)

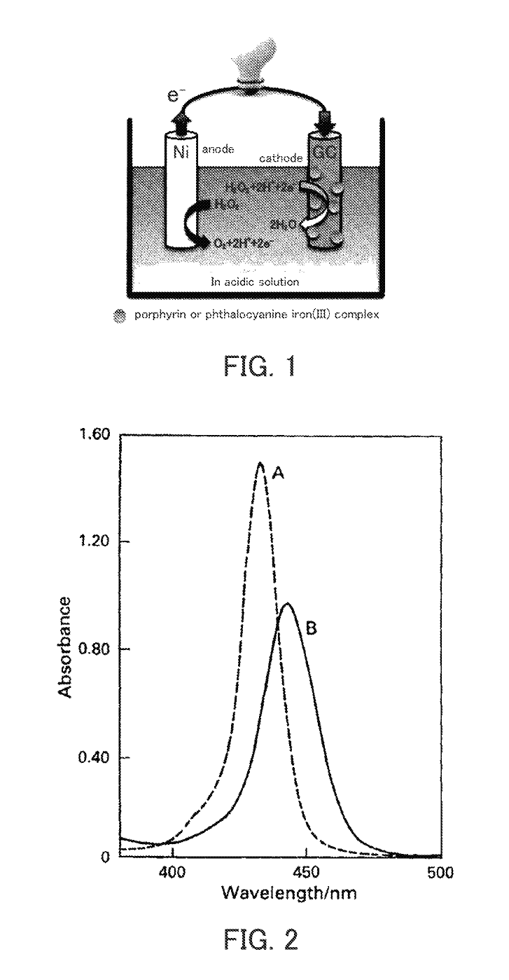

FIG. 1 schematically shows an example of a configuration of a fuel battery according to the present invention. As shown in FIG. 1, in this fuel battery, a fuel container that also functions as a fuel battery cell contains an acidic solution. The acidic solution is an aqueous solution in which oxygen (O₂) is dissolved, and the pH is adjusted to acidic. Moreover, in the acidic solution, the water oxidation catalyst and the transition metal complex are dispersed (dissolved or suspended). In the acidic solution, an anode made of nickel (Ni) and a cathode made of glassy carbon (GC) are immersed. The cathode and the anode are connected with each other by a conducting wire outside the acidic solution, so that electrons (e) can move in the conducting wire from the anode to the cathode. On the cathode, at least one kind selected from the group consisting of porphyrin complexes ([Fe(OEP)Cl], [Fe(TPP)Cl], and [Fe(Pc)Cl]) represented by the following chemical formulae (a) to (c) are immobilized. The following chemical formulae (a) to (c) represent structures of Fe(III) complexes, i.e., trivalent iron complexes, and the structures, however, may be structures in which Fe(II), i.e., bivalent iron is substituted for Fe(III). In the acidic solution, a reaction of the mathematical expression [1] occurs on the anode side, and a reaction of the mathematical expression [2] occurs on the cathode side.

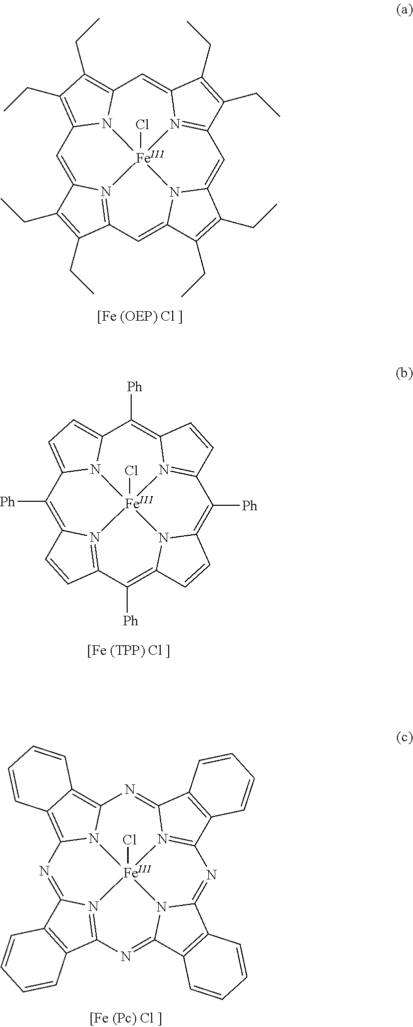

In FIG. 1, for example, a basic aqueous solution or a neutral aqueous solution may be used as a substitute for the acidic solution, and the composition and the like of the solutions may be changed as appropriate. The materials of the anode and the cathode also are not particularly limited and can be changed as appropriate.

Experimental procedures described in the Electronic Supplementary Information of Reference Example 4 are shown below. As mentioned above, the fuel battery according to the present invention may be configured with reference to the following procedures, for example, and is, however, not limited by these procedures.

[Fe(TPP)Cl], [Fe(OEP)Cl] and [Fe(Pc)Cl] were purchased from Aldrich Chemicals and used without purifying them. A Ni mesh (150 mesh) and glassy carbon electrodes (φ 3 mm or 1 cm×1 cm) were purchased from BAS. Water was purified (18.2 MΩcm) using a Milli-Q system (manufactured by Millipore, trade name: Direct-Q 3 UV).

(Immobilization of Iron Complex on Glassy-Carbon Electrode)

[Fe(TPP)Cl], [Fe(OEP)Cl], or [Fe(Pc)Cl] was dissolved in benzonitrile (0.60 mg, 1 mL) to prepare a solution. In the case of using [Fe(Pc)Cl], a trace amount of trifluoroacetic acid was added to the solution in order to increase the solubility. A small amount (7.0 μL) of the solution was applied to a glassy-carbon electrode (0.071 cm²), which was then dried for 40 minutes at 70° C. in an oven. The electrode modified by the Fe complex was immersed in a Nafion (trade name) solution (MeOH, 0.05%) and dried for 40 minutes at 70° C. in an oven. Thus, the electrode was coated with Nafion. The amount of the Fe complex immobilized on the glassy-carbon electrode was calculated based on a FeIII/FeII reduction current in a solution containing no H₂O₂. The respective electrical charges for reducing [Fe(TPP)Cl], [Fe(OEP)Cl], and [Fe(Pc)Cl] were 3.6×10⁻⁷, 7.6×10⁻⁷, and 2.9×10⁻⁶ C. The respective electric charges correspond to 3.7×10⁻¹², 7.9×10⁻¹², and 3.0×10⁻¹¹ mol of the respective complexes.

(Electrochemical Reduction of Hydrogen Peroxide by [Fe(TPP)Cl], [Fe(OEP)Cl], and [Fe(Pc)Cl])

The behavior of H₂O₂ in the electrode modified by each Fe complex was examined using an ALS 630B electrochemical analyzer (trade name). A saturated calomel electrode was used as a reference electrode, and a platinum electrode was used as a counter electrode. A glassy-carbon electrode on which [Fe(TPP)Cl], [Fe(OEP)Cl], or [Fe(Pc)Cl] was immobilized was used as a working electrode. The measurement was performed at room temperature using a phosphate buffer solution (pH 4) containing 3 mM H₂O₂.

(Performance Evaluation of H₂O₂ Fuel Battery)

A buffer solution (300 mM) having a pH from 3 to 5 and containing an H₂O₂ solution was placed in a one-compartment electrochemical cell. An Ni electrode and a glassy-carbon electrode on which [Fe(TPP)Cl], [Fe(OEP)Cl], or [Fe(Pc)Cl] was immobilized were immersed in the H₂O₂ solution. The performance of the cell was evaluated using BAS 100W (trade name). The measurement was performed in a deaired acetate buffer solution at room temperature.

### EXAMPLES

The examples of the present invention are described below. The present invention, however, is not at all limited by the following examples. For example, reaction mechanisms described in figures and the descriptions thereof are merely examples of assumable mechanisms and do not limit the present invention.

A measurement of an absorbance (ultraviolet-visible absorption spectrum) of the solution was performed using a device, 8453 photodiode array spectrophotometer (trade name) manufactured by Hewlett-Packard. A measurement of an ultraviolet-visible absorption spectrum by diffuse reflectance spectroscopy was performed using Shimadzu UV-3300PC (trade name) and ISR-3100 (trade name) as an accessory thereof, both manufactured by Shimadzu Corporation. A measurement by voltammetry (cyclic voltammetry, CV) was performed using a device, ALS630B electrochemical analyzer (trade name) manufactured by BAS. A measurement by dynamic light scattering (DLS) was performed using Zeta Sizer Nano ZS (trade name) manufactured by Malvern Instruments Ltd. in the United States. A measurable range by DLS using this device is from 0.6 to 6000 nm. Thermal gravity-differential thermal simultaneous analysis (thermogravimetric analysis/differential thermal analysis, TG/DTA) was performed using TG/DTA 7200 (trade name) manufactured by SII. A measurement by X-ray photoelectron spectroscopy was performed using AXIS-165 (trade name) manufactured by Kratos. A BET for surface area measurement was performed using Belsorp II mini (trade name) manufactured by Bel JAPAN. As a xenon lamp, Ushio Optical ModelX SX-UID 500XAMQ (trade name, wavelength λ>390 nm, output: 500 W) manufactured by USHIO INC. was used Irradiation with monochromatic light was performed using fluorospectrophotometer RF-5300PC (trade name), shimadzu, manufactured by Shimadzu Corporation was used. All of the chemical substances were of the reagent grade and purchased from Tokyo Chemical Industry Co., Ltd., Wako Pure Chemical Industries, Ltd., Aldrich, or NACALAI TESQUE, INC., unless otherwise mentioned.

The quantitative determination of hydrogen peroxide was performed using a titanium-porphyrin complex TiO(tpypH₄)⁴⁺ represented by the chemical formula described in the following scheme 3. That is, an aqueous solution containing hydrogen peroxide dissolved therein after the reaction was mixed with a solution (hereinafter referred to as a Ti-TPyP reagent) obtained by dissolving TiO(tpypH₄)⁴⁺ in an aqueous HCl solution. Thus, as shown below, the TiO(tpypH₄)⁴⁺ reacted with the hydrogen peroxide to generate TiO₂(tpypH₄)⁴⁺. An absorption spectrum (absorption band) of TiO(tpypH₄)⁴⁺ is different from that of TiO₂(tpypH₄)⁴⁺. Thus, by measuring the spectra, the hydrogen peroxide can be quantitatively determined from the generated amount of TiO₂(tpypH₄)⁴⁺.

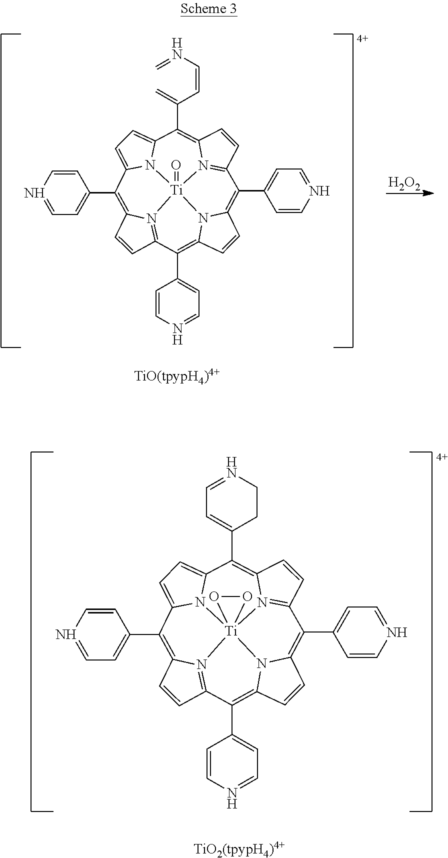

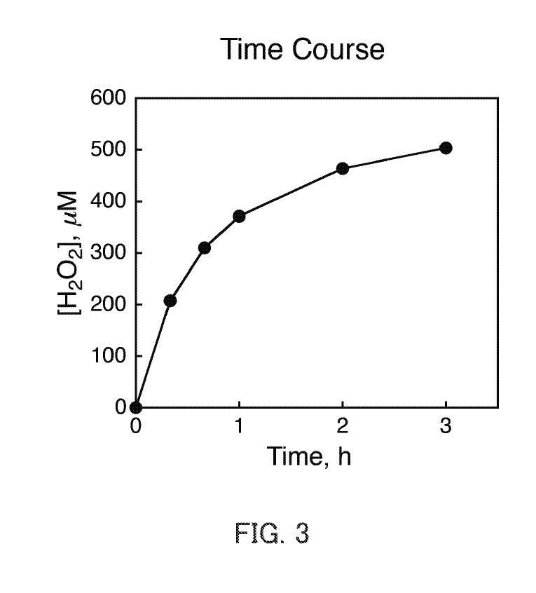

FIG. 2 shows a graph showing visible absorption spectra of TiO(tpypH₄)⁴⁺ and TiO₂(tpypH₄)⁴⁺. In FIG. 2, the horizontal axis indicates a wavelength (nm), and the vertical axis indicates an absorbance. A curved line indicated by a dashed line (A) represents the absorption spectrum of TiO(tpypH₄)⁴⁺ (Ti-TPyP reagent). A curved line indicated by a solid line (B) represents the absorption spectrum of TiO₂(tpypH₄)⁴⁺. As shown in FIG. 2, it was found that the maximum absorption wavelength of TiO₂(tpypH₄)⁴⁺ was shifted to a longer wavelength side compared with that of TiO(tpypH₄)⁴⁺. FIG. 2 is the same as FIG. 1 of Reference Document 5 below and FIG. 3 of Reference Document 6 below. The quantitative determination of hydrogen peroxide using TiO(tpypH₄)⁴⁺ (Ti-TPyP reagent) can be performed with reference to Reference Document 5 or 6 below in addition to the present example, for example.
[Reference Document 5]
ANALYST, NOVEMBER 1992, VOL. 117, 1781-1784
[Reference Document 6]
Bull. Chem. Soc. Jpn., 76, 1873

[Synthesis of Iridium Oxide (Ira)]

Iridium oxide (water oxidation catalyst) used in production of hydrogen peroxide was synthesized as follows. First, 50 mL of water was added to commercially available H₂IrCl₆.6H₂O (1 g), which was then stirred. An aqueous NaOH solution (5M) was added to a resultant mixture so as to adjust the pH thereof to 10, which was then heated for 30 minutes at 100° C. in an oil bath. This mixture was left at room temperature and then filtered. Thus, a solid was obtained. This solid was dried using a vacuum pump at normal temperature and further dried in air for 12 hours at 65° C. Thus, IrOₓ was obtained. In this IrOₓ, x was unknown (unidentified). Hereinafter, when IrOₓ is described, the IrOₓ indicates this self-prepared IrOₓ unless otherwise mentioned. Moreover, in FIGS. 1 to 22, a notation of “Ir(OH)₃” means IrOₓ. The reason why the notation of “Ir(OH)₃” was used was because it was assumed by XPS measurement that Ir(OH)₃ exists in large amount on the surface of IrOₓ as shown in Reference Example 3 described below. However, this notation is for the sake of convenience and does not limit the structure of IrOₓ.

### Example 1

### Production of Hydrogen Peroxide

[Ru^{II}(Me₂-phen)₃]Cl₂ (20 μM) and IrOₓ (3.0 mg) were added to an aqueous H₂SO₄ solution (2M, 3.0 mL), and a stirring bar was placed thereinto. Thereafter, the mixture thus obtained was sealed in a cell with two optical windows that has an optical path length of 1 cm using a rubber septum, and oxygen gas replacement was performed. That is, a reaction system containing water, a water oxidation catalyst (IrOₓ), a transition metal complex ([Ru^{II}(Me₂-phen)₃]Cl₂), and oxygen (O₂) was prepared as described above. [Ru^{II}(Me₂-phen)₃]Cl₂ was a divalent ruthenium complex represented by the chemical formula (4). Then, the reaction system was irradiated with only light with a wavelength of more than 420 nm (wavelength λ>420 nm) obtained after passing through a colored glass filter (L42, AGC TECHNOGLASS) to cut light with a wavelength of 420 nm or less, using a xenon lamp light source (Ushio Optical Modulex SX-UID 501XAMQ). The hydrogen peroxide after the reaction was quantitatively determined using a commercially available product of a TiO(tpypH₄)⁴⁺ salt. That is, first, TiO(tpypH₄)⁴⁺ (50 μM) was added to an aqueous HCl solution (50 mM) to prepare a Ti-TPyP reagent. The reaction system (reaction solution) after the reaction was filtered to remove impurities and was diluted with water. 0.25 ml of HClO₄ (4.8 M) and 0.25 mL of the Ti-TPyP reagent were added to 0.25 mL of this solution thus obtained, and the resultant solution was left for 5 minutes. Thereafter, the solution was diluted with water to be 2.5 mL, and a visible absorption spectrum thereof was measured to quantitatively determine the hydrogen peroxide. Since the degree of ionization of diluted sulfuric acid was nearly 100%, it could be estimated that the pH of a 2 M aqueous sulfuric acid H₂SO₄ solution was about −0.60, for example.

The divalent ruthenium complex [Ru^{II}(Me₂-phen)₃]Cl₂ was synthesized by a method described in Reference Document 7 below. Specifically, first, ruthenium(III) trichloride (RuCl₃) (82.97 mg, 0.4 mmol) and 4,7-dimethyl-1,10-phenanthroline (499.82 mg, 2.4 mmol) were added to a mixed solvent of ethanol (16 mL) and deionized purified water (4 mL). The resultant solution was then heated and refluxed for 48 hours at 100° C. under a nitrogen atmosphere. Thereafter, the obtained orange-red solution was distilled under reduced pressure, was then dissolved in acetone, and was recrystallized with diethylether. Thus, [Ru^{II}(Me₂-phen)₃]Cl₂ was obtained. A salt of the divalent ruthenium complex [Ru^{II}(bpy)₃]Cl₂ represented by the chemical formula (5) also can be synthesized in the same manner as described above.
[Reference Document 7]
Nocera, D. G.; Turro, C.; Zaleski, J. M.; Karabatsos, Y. M. J. Am. Chem. Soc. 1996, 118, 6060.

A graph of FIG. 3 shows a result of the quantitative determination of hydrogen peroxide in Example 1. In FIG. 3, the horizontal axis indicates a reaction time, i.e., time for irradiation with light (h), and the vertical axis indicates a concentration (μM) of hydrogen peroxide in the reaction system (reaction solution). In Example 1, the TON (based on [Ru^{II}(Me₂-phen)₃]Cl₂) at the reaction time of 3 h was 25 which was really high. The present invention is the first time to provide the production method by which hydrogen peroxide can be produced with high efficiency using oxygen and water as raw materials as described above.

### Example 2

[Ru^{II}(Me₂-phen)₃]Cl₂ (20 μM) and IrOₓ (3.0 mg) were added to an aqueous H₂SO₄ solution (2 M, 3.0 mL), and a stirring bar was placed therein. Thereafter, the mixture thus obtained was sealed in a cell with two optical windows that has an optical path length of 1 cm using a rubber septum, and oxygen gas replacement was performed. Subsequently, a reaction was caused to be performed in the mixture using fluorospectrophotometer RF-5300PC (trade name), simadzu, manufactured by Shimadzu Corporation with a slit width of 5 nm at a wavelength of 450 nm. Thereafter, the hydrogen peroxide was quantitatively determined using TiO(tpypH₄)⁴⁺. The light intensity at the time of the determination was 1.1×10⁻⁹ einstein s⁻¹.

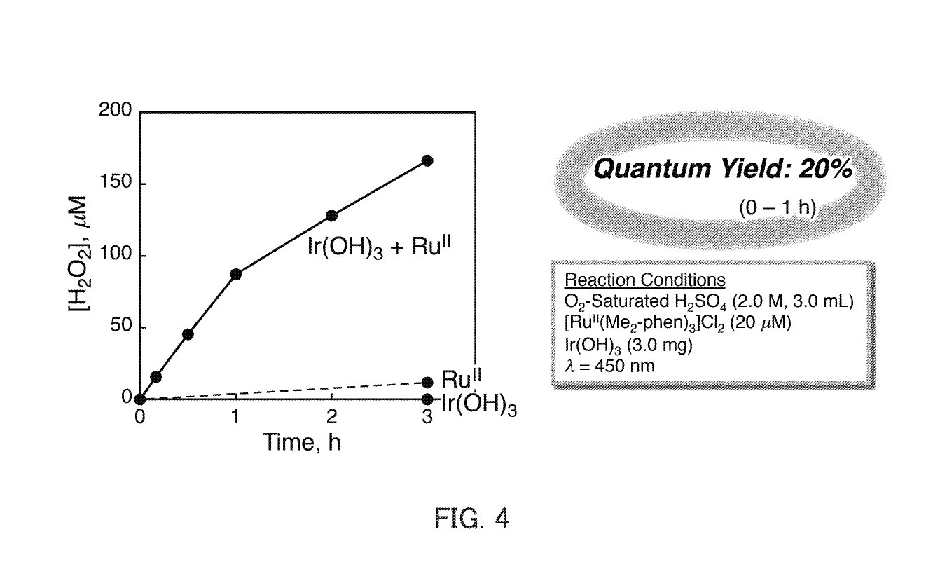

A graph of FIG. 4 shows a result of the quantitative determination of hydrogen peroxide in Example 2. In FIG. 2, the horizontal axis indicates a reaction time, i.e., time for irradiation with light (h), and the vertical axis indicates a concentration of hydrogen peroxide in the reaction system (reaction solution) (μM). As shown in FIG. 4, in Example 2, the TON (based on [Ru^{II}(Me₂-phen)₃]Cl₂) at the reaction time of 3 h was 8.3 which was really high. Furthermore, in the present example (Example 2), a quantum yield was determined using actinometer (potassium tris(oxalato)ferrate(III) trihydrate). The quantum yield was about 20% after 0 to 1 hour from the initiation of the reaction. The quantum yield of photosynthesis in nature is about 1% at the highest. Thus, it could be said that about 20% of the quantum yield was really high. It was assumed that oxygen (O₂) was generated by oxidation of water as in the schemes 1 and 2 in the hydrogen peroxide production method according to the present invention. Thus, it was considered that the reaction mechanism is the same as photosynthesis in this way. Please note that the present invention is not limited by the schemes 1 and 2 as mentioned above.

### Reference Example 1

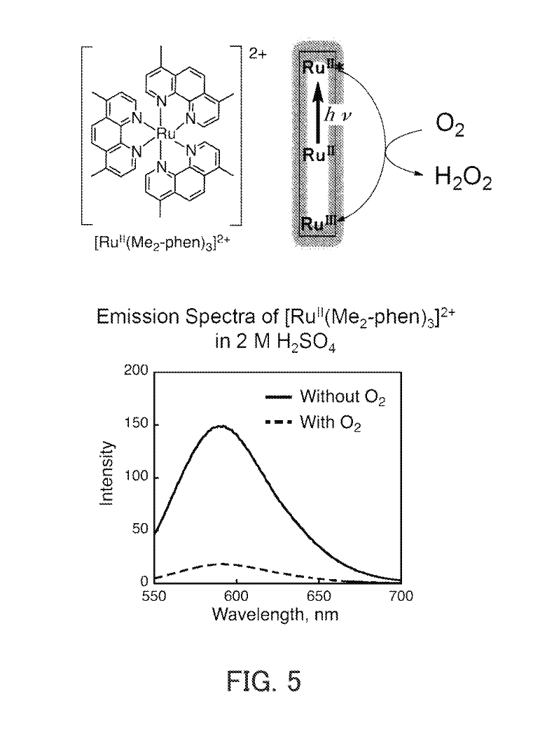

A reaction was performed in the same manner as in Example 2 except that a water oxidation catalyst was not added to a reaction system. Moreover, a reaction was performed in the same manner as described above except that oxygen (O₂) was not present in the system (deaeration was performed by argon replacement). FIG. 5 shows the results of the reactions. In FIG. 5, a lower graph shows fluorescence spectra of the aqueous solutions after the respective reactions, and the horizontal axis indicates a wavelength (nm), and the vertical axis indicates fluorescence intensity (a relative value). In the lower graph of FIG. 5, a solid line represents a fluorescence spectrum obtained after the irradiation with light in the absence of oxygen (O₂), and a dashed line represents a fluorescence spectrum obtained after the irradiation with light in the presence of oxygen (O₂). An upper scheme of FIG. 5 is an assumable reaction mechanism when oxygen (O₂) is present. As shown in the lower graph of FIG. 5, after the irradiation with light in the absence of oxygen (O₂), a fluorescence spectrum based on [Ru^{II}(Me₂-phen)₃]²⁺ was shown, and after the irradiation with light in the presence of oxygen (O₂), fluorescence almost disappeared. It was assumed that this was because when oxygen (O₂) was not present, the reaction hardly occurred, and when oxygen (O₂) was present, [Ru^{II}(Me₂-phen)₃]²⁺ and oxygen (O₂) reacted with each other to generate [Ru^{III}(Me₂-phen)₃]³⁺ (trivalent ruthenium ion) and hydrogen peroxide as shown in the scheme of FIG. 5. Please note that in the case of the present reference example, [Ru^{II}(Me₂-phen)₃]²⁺ does not serve as a catalyst as in Example 1, and hydrogen peroxide was slightly generated. It was assumed that this was because since a water oxidation catalyst was not present, the generated [Ru^{III}(Me₂-phen)₃]³⁺ (trivalent ruthenium ion) was not reduced (retuned to a divalent ruthenium ion), and thus, the generation of hydrogen peroxide was stopped when [Ru^{II}(Me₂-phen)₃]²⁺ (divalent ruthenium ion) ran out.

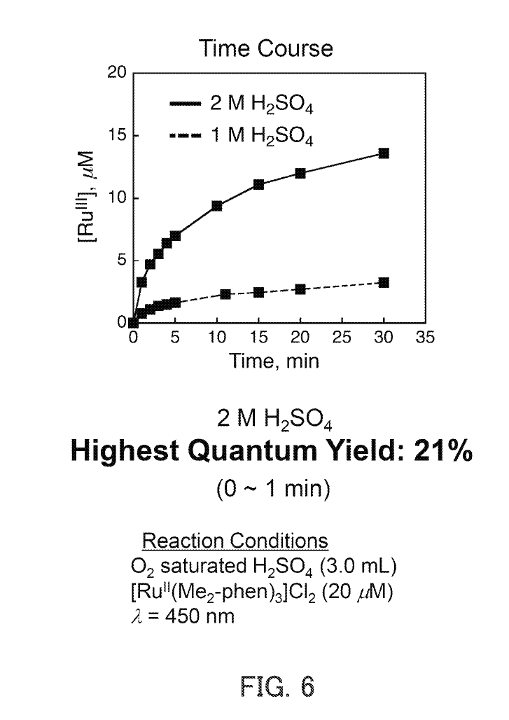

Moreover, the concentration of sulfuric acid H₂SO₄ was changed, and the quantum yields at the respective concentrations of sulfuric acid of 2M (the same as in Example 2) and 1M were determined. The results of the determination are shown in FIG. 6. In FIG. 6, the horizontal axis indicates a reaction time, i.e., time for irradiation with light (minute), and the vertical axis indicates a concentration (μM) of [Ru^{III}(Me₂-phen)₃]³⁺ in the reaction system (reaction solution), calculated from each fluorescence spectrum. As shown in FIG. 6, the concentration of [Ru^{III}(Me₂-phen)₃]³⁺ after the reaction was higher when the concentration of sulfuric acid was 2 M. Thus, it was found that reaction efficiency was higher when concentration of sulfuric acid was 2 M. Moreover, the quantum yield when the concentration of sulfuric acid was 2 M was 21% (after 0 to 1 minute from the initiation of the reaction) which showed a good match with the result of Example 2.

### Reference Example 2

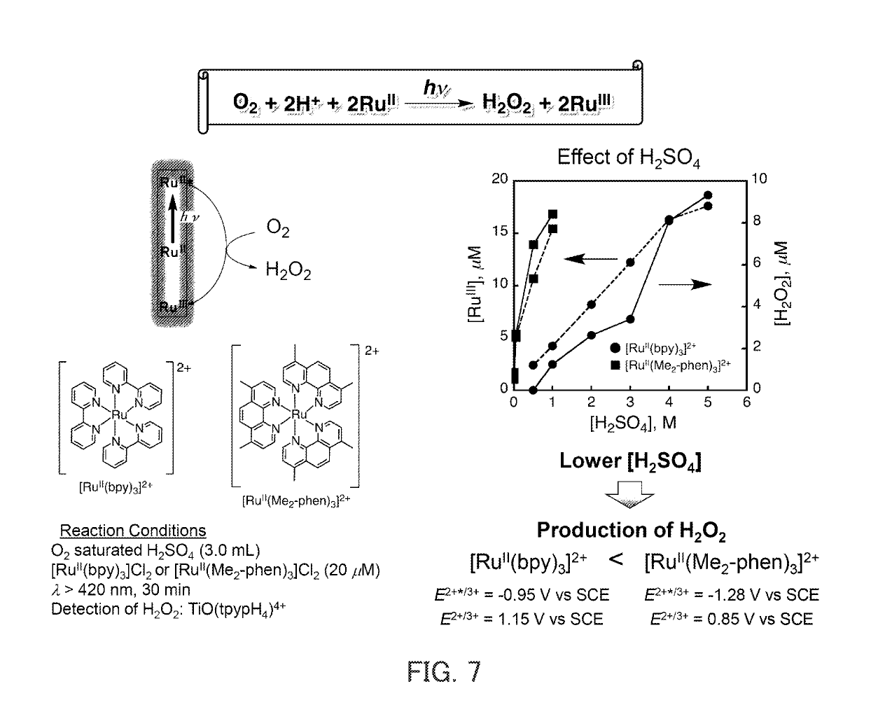

A reaction was performed with a time for irradiation with light (reaction time) of 30 minutes in the same manner as in Example 1 except that [Ru^{II}(Me₂-phen)₃]Cl₂ (a salt of a ruthenium complex represented by the chemical formula (4), which is the same as in Example 1) or [Ru^{II}(bpy)₃]Cl₂ (a salt of a ruthenium complex represented by the chemical formula (5)), was used as a transition metal complex, the concentration of sulfuric acid H₂SO₄ was variously changed, and a water oxidation catalyst (IrOₓ) was not used. The results of the reaction are shown in a graph of FIG. 7. In FIG. 7, the horizontal axis indicates a concentration (M) of sulfuric acid H₂SO₄, and the vertical axis indicates a concentration (μM) of a trivalent ruthenium complex or a concentration (μM) of hydrogen peroxide H₂O₂. As shown in FIG. 7, in the case of using any of the complexes, the higher the concentration of sulfuric acid was, the higher the amount of generation of hydrogen peroxide was. It was considered that this was because the higher the proton concentration was, the more easily the reaction of generating hydrogen peroxide from oxygen (O₂) occurred. When the concentration of sulfuric acid was the same, the amount of hydrogen peroxide generated was higher in [Ru^{II}(Me₂-phen)₃]Cl₂ (a salt of a ruthenium complex represented by the chemical formula (4), which is the same as in Example 1). As shown in FIG. 7, the concentration of the hydrogen peroxide showed a good match with the concentration of the ruthenium complex.

### Example 3

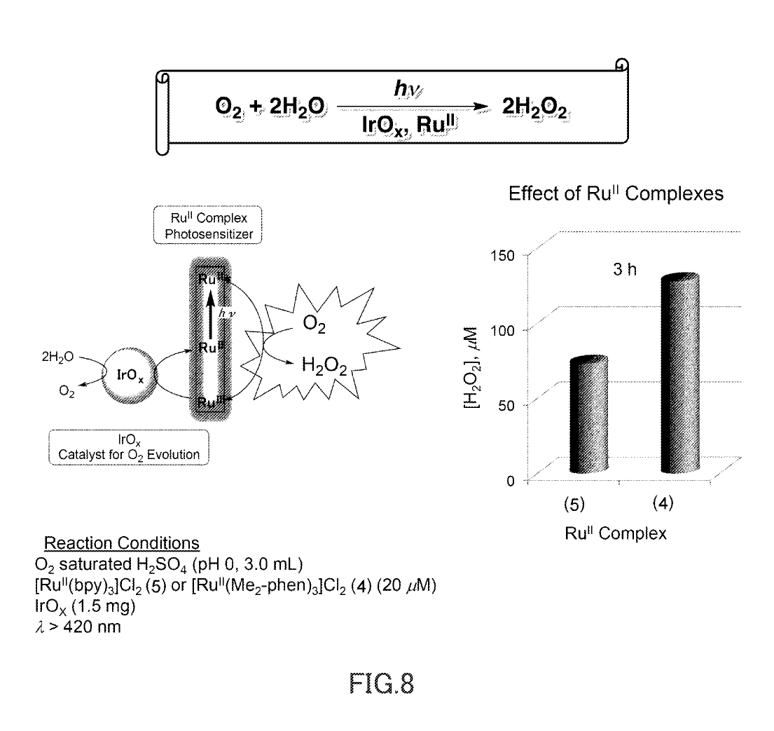

A reaction was performed with a time for irradiation with light (reaction time) of 30 minutes in the same manner as in Example 1 except that [Ru^{II}(Me₂-phen)₃]Cl₂ (a salt of a ruthenium complex represented by the chemical formula (4), which is the same as in Example 1), or [Ru^{II}(bpy)₃]Cl₂ (a salt of a ruthenium complex represented by the chemical formula (5)) was used as a transition metal complex, the pH of a reaction system was adjusted to 0 by adjusting the concentration of sulfuric acid H₂SO₄, and the amount of IrOₓ used was 1.5 mg. The results of the reaction are shown in FIG. 8. In a right graph of FIG. 8, the horizontal axis indicates a kind of the transition metal complex (the chemical formula (4) or (5)), and the vertical axis indicates a concentration (μM) of hydrogen peroxide H₂O₂ in the reaction system (water) after 3 hours from the initiation of the reaction. As shown in FIG. 8, in the case of using any of the transition metal complexes, hydrogen peroxide H₂O₂ could be efficiently obtained. The amount of the hydrogen peroxide H₂O₂ in the case of using [Ru^{II}(Me₂-phen)₃]Cl₂ (a salt of a ruthenium complex represented by the chemical formula (4), which is the same as in Example 1) was higher (about twice), compared with the case of using [Ru^{II}(bpy)₃]Cl₂ (a salt of a ruthenium complex represented by the chemical formula (5)).

### Example 4

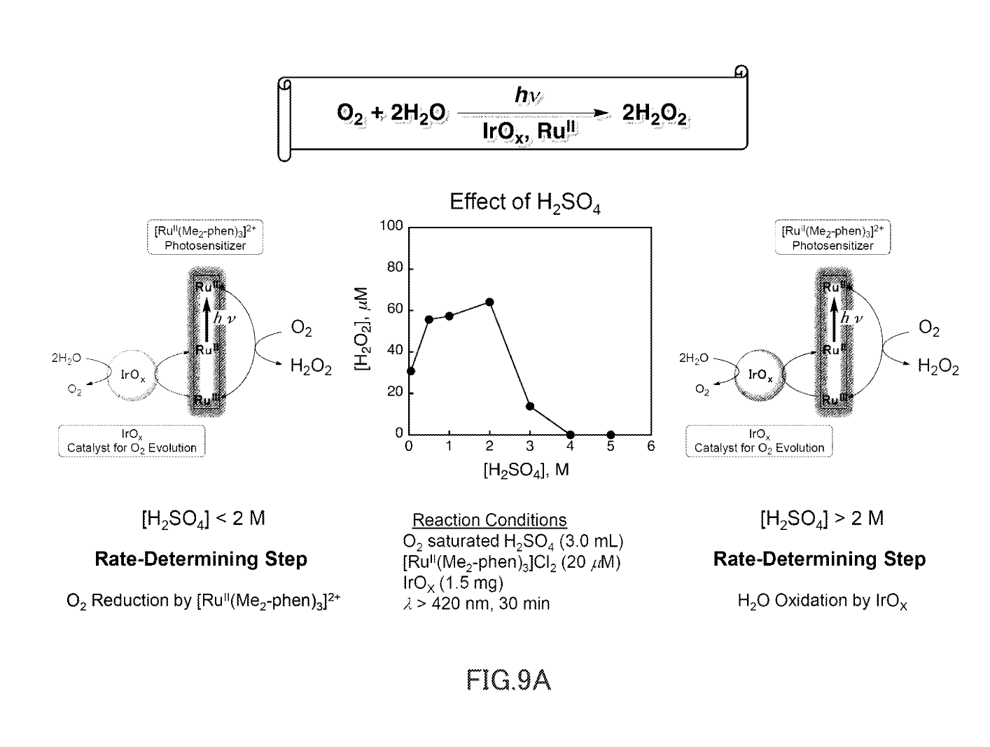

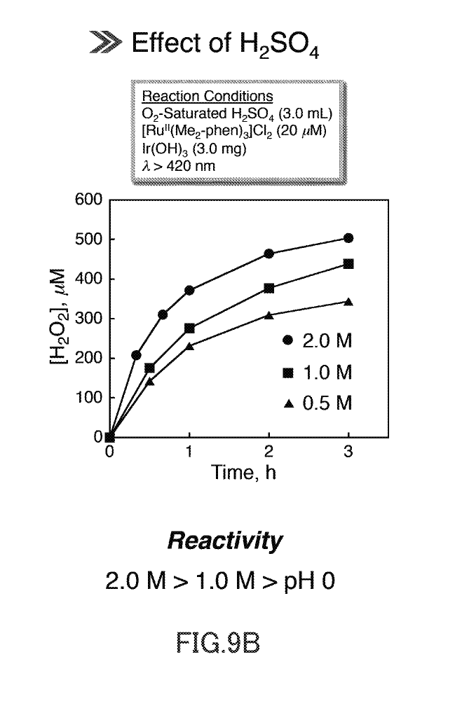

A reaction was performed with a time for irradiation with light (reaction time) of 30 minutes in the same manner as in Example 1 except that the concentration of sulfuric acid H₂SO₄ was variously changed, and the amount of use of IrOₓ was 1.5 mg. The results of the reaction are shown in FIG. 9A. In a middle graph of FIG. 9A, the horizontal axis indicates a concentration (M) of sulfuric acid H₂SO₄ in the reaction system (water), and the vertical axis indicates a concentration (μM) of hydrogen peroxide H₂O₂ after the reaction. As shown in the middle graph of FIG. 9A, the concentration of the sulfuric acid was changed from 0 M to 5 M, and the concentration of hydrogen peroxide H₂O₂ after the reaction was the highest (i.e., the amount of generation of hydrogen peroxide H₂O₂ was the highest) when the concentration of sulfuric acid was 2 M. The reason for this was assumed as follows. That is, as shown in a left schematic view of FIG. 9A, it was considered that an oxidation reaction of water by IrOₓ (generation of O₂ from H₂O) easily occurs under the condition where the concentration of sulfuric acid was low (i.e., weakly acid because of a high pH), so that a reduction reaction of O₂ by a transition metal complex (generation of H₂O₂) was in a rate-determining step. On the other hand, the reduction reaction of O₂ (generation of H₂O₂) easily occurs under the condition where the concentration of sulfuric acid is high (i.t., strongly acid because of a low pH), so that the oxidation reaction of water by IrOₓ (generation of O₂ from H₂O) is in a rate-determining step. It was assumed that the efficiency of generation of H₂O₂ was the highest in the reaction system of the present invention when the concentration of sulfuric acid was 2 M from the viewpoint of a balance of these reactions. The results of a reaction performed under the same conditions as in FIG. 9A except that the amount of use of IrOₓ was 3.0 mg, and tracking was performed from 0 to 3 h of the time for irradiation with light are shown in FIG. 9B. As shown in FIG. 9B, the concentration of hydrogen peroxide at the same reaction time was increased with an increase in concentration of sulfuric acid (0.5 M<1 M<2 M) even under the reaction conditions of FIG. 9B as in the case under the reaction conditions of FIG. 9A. Although not shown in FIG. 9B, in the case where the concentration of sulfuric acid was any of 3 M and 4 M under the reaction conditions of FIG. 9B, the concentration of hydrogen peroxide was low compared with the case where the concentration of sulfuric acid was 0.5 M as in FIG. 9A.

### Example 5

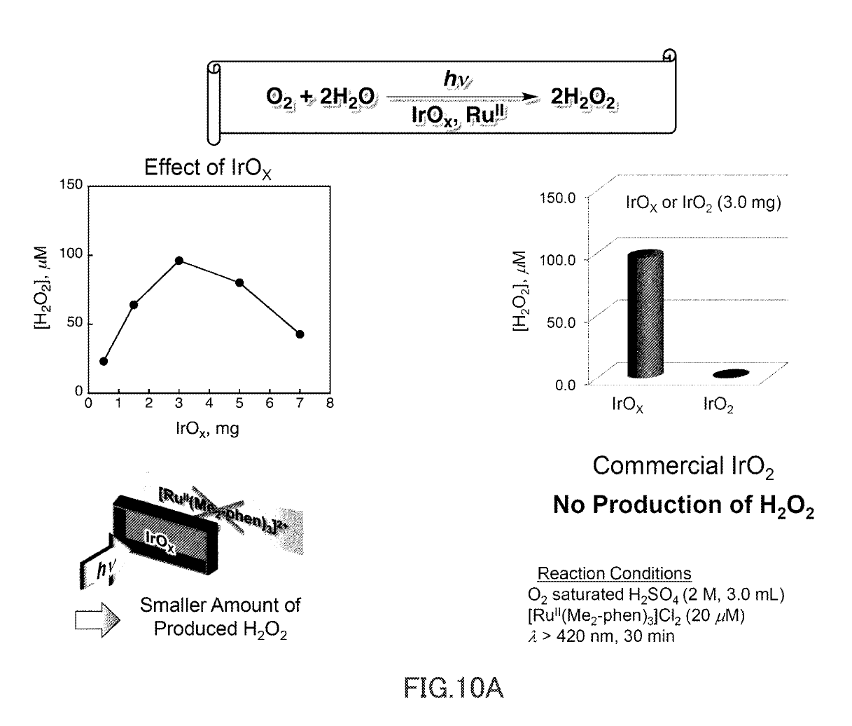

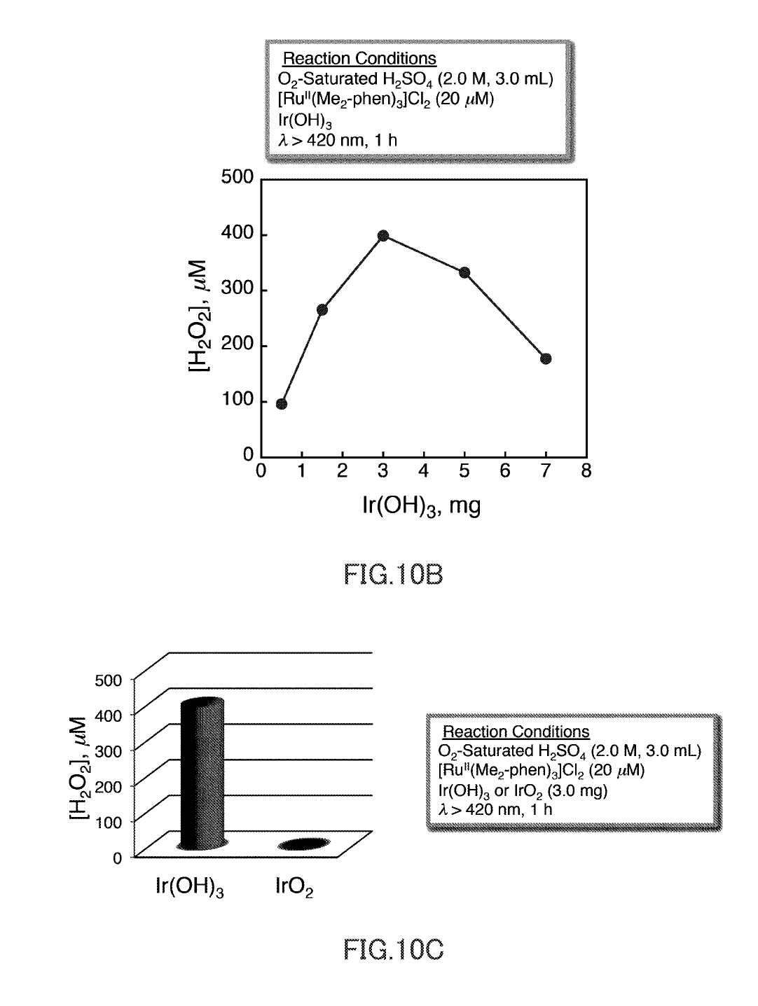

A reaction was performed with a time for irradiation with light (reaction time) of 30 minutes in the same manner as in Example 1 except that the amount of IrOₓ used was variously changed. The results of the reaction are shown in a left graph of FIG. 10A. In the left graph of FIG. 10A, the horizontal axis indicates an amount (mg) of use of IrOₓ, and the vertical axis indicates a concentration (μM) of hydrogen peroxide H₂O₂ after the reaction. As shown in the left graph of FIG. 10A, the concentration of hydrogen peroxide H₂O₂ after the reaction was the highest (i.e., the amount of generation of hydrogen peroxide H₂O₂ was the highest) when the amount of use of IrOₓ was 3 mg. Furthermore, the results of a reaction performed under the same conditions as in the left graph of FIG. 10A except that a time for irradiation with light (reaction time) was 1 hour are shown in a graph of FIG. 10B. In the left graph of FIG. 10B, the horizontal axis indicates an amount (mg) of IrOₓ used, and the vertical axis indicates a concentration (μM) of hydrogen peroxide H₂O₂ after the reaction. As shown in the left graph of FIG. 10B, even though the reaction time was 1 hour, the concentration of hydrogen peroxide H₂O₂ after the reaction was the highest (i.e., the amount of generation of hydrogen peroxide H₂O₂ was the highest) when the amount of IrOₓ used was 3 mg as in the case where the reaction time was 30 minutes (a left graph of FIG. 10A). The reason for this is not always clear. However, it was considered that when IrOₓ to be used was excessive in amount, absorption (excitation) of light by the transition metal complex was easily prevented by the IrOₓ dispersed (suspended) in the reaction system, and thus, a balance was well-maintained when the amount of use of IrOₓ was 3 mg.

### Reference Example 3

A reaction was performed with a time for irradiation with light (reaction time) of 30 minutes in the same manner as in Example 1 except that 3 mg of IrOₓ or a commercially available iridium (IV) oxide, i.e., IrO₂ (purity: 99%, manufactured by STREM CHEMICALS) was used. The results of the reaction are shown in a right graph of FIG. 10A The horizontal axis indicates which of the IrOₓ and the commercially available IrO₂ was used, and the vertical axis indicates a concentration (μM) of hydrogen peroxide H₂O₂ after the reaction. As shown in the right graph of FIG. 10A, hydrogen peroxide H₂O₂ could be efficiently obtained when the IrOₓ (the same conditions as in Example 1) was used, and hydrogen peroxide H₂O₂ was hardly obtained when the commercially available IrO₂ was used. This was because almost all of the commercially available IrO₂ was precipitated and thus was not efficiently dispersed in the reaction system (water). The results of a reaction performed under the same conditions as in the right graph of FIG. 10A except that a time for irradiation with light (reaction time) was 1 hour are shown in a graph of FIG. 10C. In the graph of FIG. 10C, the horizontal axis indicates which of the IrOₓ and the commercially available H₂O₂ was used, and the vertical axis indicates a concentration (μM) of hydrogen peroxide H₂O₂ after the reaction. As shown in the graph of FIG. 10C, even though the reaction time was 1 hour, hydrogen peroxide H₂O₂ could be efficiently obtained when the IrOₓ was used, and hydrogen peroxide H₂O₂ was hardly obtained when the commercially available IrO₂ was used. The reason why the amount of hydrogen peroxide H₂O₂ generated is different between the IrOₓ and the commercially available IrO₂ is not always clear. However, there is a possibility that a hydroxyl group (OH) is present on the surface of IrOₓ, and the hydroxyl group accelerates dispersibility of IrOₓ in water or reactivity of IrOₓ itself.

The specific surface area of the commercially available IrO₂ was measured by BET for surface area measurement and was 0.8 m²/g. The specific surface area of the IrOₓ was measured in the same manner as described above and was 22.1 m²/g which was about 28 times the specific surface area of the commercially available IrO₂.

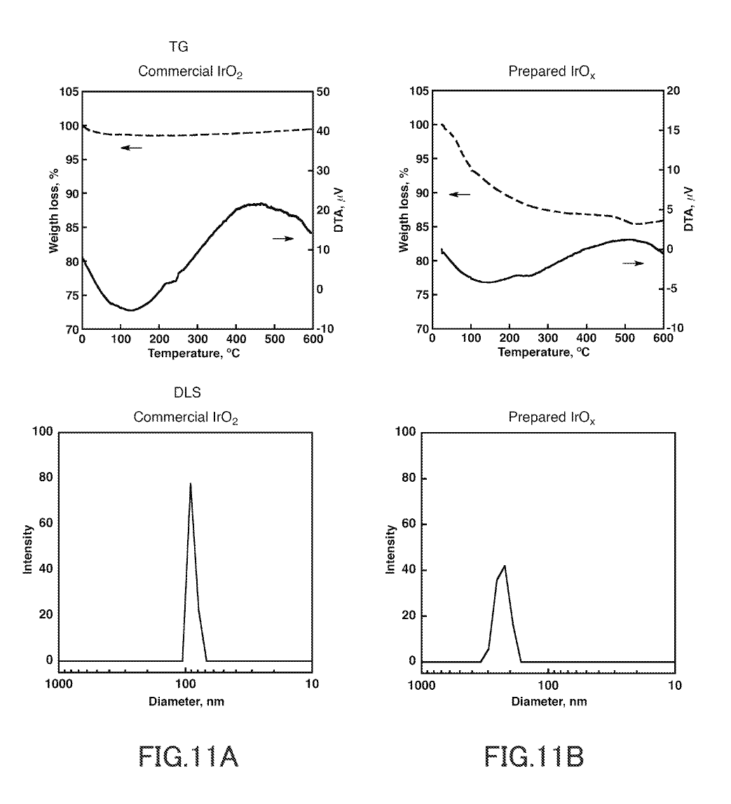

Measurement results of IrOₓ and the commercially available IrO₂ by thermogravimetric analysis/differential thermal analysis (thermal gravity-differential thermal simultaneous analysis, TG/DTA) and dynamic light scattering (DLS) are shown in graphs of FIG. 11. Among four graphs (an upper left graph, an upper right graph, a lower left graph, and a lower right graph) shown in FIG. 11, two left graphs show measurement results of the commercially available IrO₂, and two right graphs show measurement results of the IrOₓ. Moreover, two upper graphs show measurement results by thermal gravity-differential thermal simultaneous analysis (TG/DTA) and two lower graphs show measurement results by dynamic light scattering (DLS). In the two upper graphs, the horizontal axis indicates a temperature (° C.), and the vertical axis indicates a weight of a sample to be measured (indicated by Weight loss in the graphs) or an electrical potential (μV) measured by differential thermal simultaneous analysis (DTA). The Weight loss represents a percentage assuming that the weight of the sample to be measured before the initiation of the measurement is 100%. In the two lower graphs, the horizontal axis indicates a particle size (nm) of the sample to be measured, and the vertical axis indicates intensity (a relative value). The thermal gravity-differential thermal simultaneous analysis (TG/DTA) was performed by heating the sample (about 3 mg) from 25° C. to 600° C. at a temperature increase rate of 2° C./min and maintaining the sample at 100° C. for 10 mins, using TG/DTA 7200 manufactured by SE. In the measurement by DTA, γ-Al₂O₃ was used as a reference substance. In the measurement by dynamic light scattering (DLS), as mentioned above, Zeta Sizer Nano ZS (trade name) manufactured by Malvern Instruments Ltd. in the United States was used. A measurable range by DLS using this device is from 0.6 to 6000 nm. The measurement by DLS was performed by suspending the commercially available IrO₂ (0.1 mg) or a self-prepared IrOₓ (0.1 mg) in distilled water (1.5 mL).

A decrease in weight of the IrOₓ was large compared with the commercially available IrO₂. Thus, it was considered from the measurement by TG that the IrOₓ has a high water content compared with the commercially available IrO₂. It is not contradictory to consider that this process is an endothermic process and a dehydration process from DTA.

As shown in the measurement results by DLS, a measurement value of the particle size of IrOₓ was higher than that of the commercially available IrO₂. The commercially available IrO₂ actually contains particles with really high particle sizes. However, when the commercially available IrO₂ is kept still, the particles thereof are precipitated without dispersing. Thus, it was considered that in the measurement by DLS, particle sizes of a small amount of particles dispersed in supernatant are measured. In contrast, the IrOₓ was highly dispersed in water, and even when the IrOₓ was stood still, a precipitate was not generated. As shown in the lower right graph of FIG. 11, the particle size of the IrOₓ was about 220 nm and was constant. Moreover, as shown in the examples, this IrOₓ has high catalytic activity as a water oxidation catalyst.

FIG. 13 shows measurement results obtained by subjecting the IrOₓ and the commercially available IrO₂ to XPS. A right graph of FIG. 13 is a graph showing the measurement results by XPS. A left reference figure of FIG. 13 is a graph showing measurement results obtained by subjecting iridium oxide by XPS in Hara, M. and co-workers. Electmchim. Acta 1983, 28, 1073. In both of the graphs, the horizontal axis indicates binding energy (eV, electron volt) derived from the Ir (4 f) spin orbit, and the vertical axis indicates peak intensity (a relative value). In the left graph of FIG. 13, a dotted line represents a curved line with peaks, derived from Ir³⁺, a dashed line represents a curved line with peaks, derived from Ir⁴⁺, and a solid line represents superposition of both of the curved lines with peaks. As shown in the left graph of FIG. 13, each of Ir³⁺ and Ir⁴⁺ has two big peaks. A right peak (about 62.0 electron volt) represented by the dotted line is derived from Ir³⁺. A right peak (about 63.7 electron volt) represented by the dashed line is derived from Ir⁴⁺. Comparing the dotted line (superposition of Ir³⁺ and Ir⁴⁺) and the dashed line (Ir³⁺), the dashed line (Ir³⁺) is characterized by the left peak being bigger than the right peak. In the right graph of FIG. 13, a solid line represents the measurement results obtained by subjecting IrOₓ to XPS, and a dashed line represents the measurement results obtained by subjecting the commercially available IrO₂ to XPS. According to the comparison of both of the graphs in FIG. 13, each of the curved line with peaks of the IrOₓ and the curved line with peaks of the commercially available IrO₂ showed superposition of the curved line with peaks derived from Ir³⁺ and the curved line with peaks derived from Ir⁴⁺. Specifically, in the curved line of the IrOₓ, the right peak was bigger than the left peak. Thus, it was determined that the measured iridium atom has a high content of Ir³⁺. That is, it was considered that among the iridium atoms on the surface of the IrOₓ, most of them were Ir³⁺, and the amount of Ir⁴⁺ was small.

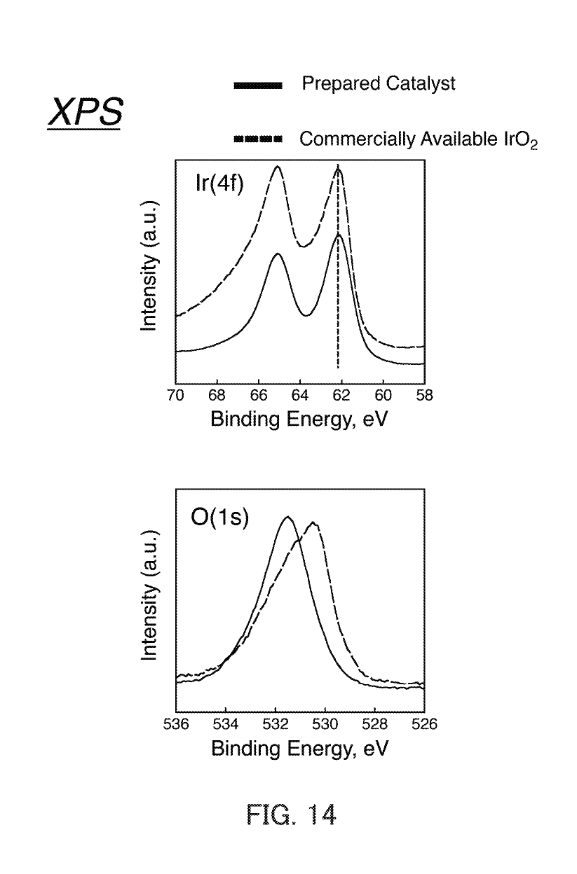

FIG. 14 shows measurement results by the same XPS as in FIG. 13. An upper graph of FIG. 14 is the same as the right graph of FIG. 13 and indicates binding energy derived from the Ir (4 f) spin orbit. A lower graph of FIG. 14 shows binding energy derived from 0 (1 s) spin orbit in the measurement by the same XPS. In both of the graphs, the horizontal axis indicates binding energy (eV, electron volt), and the vertical axis indicates peak intensity (a relative value). As shown in the lower graph of FIG. 14, in the peaks of oxygen (1 s), a peak of the IrOₓ (solid line) was shifted to a high-energy side compared with the peak of the commercially available IrO₂ (dashed line). The reason for this is not always clear. However, it was considered that an oxygen atom formed an OH covalent bond on the surface of IrOₓ to stabilize, and thus, energy was required for ionization. Thus, it was assumed that a significant proportion of oxygen on the surface of IrOₓ was present as an OH group.

### Reference Example 4

### Generation of Oxygen Using Water Oxidation Catalyst

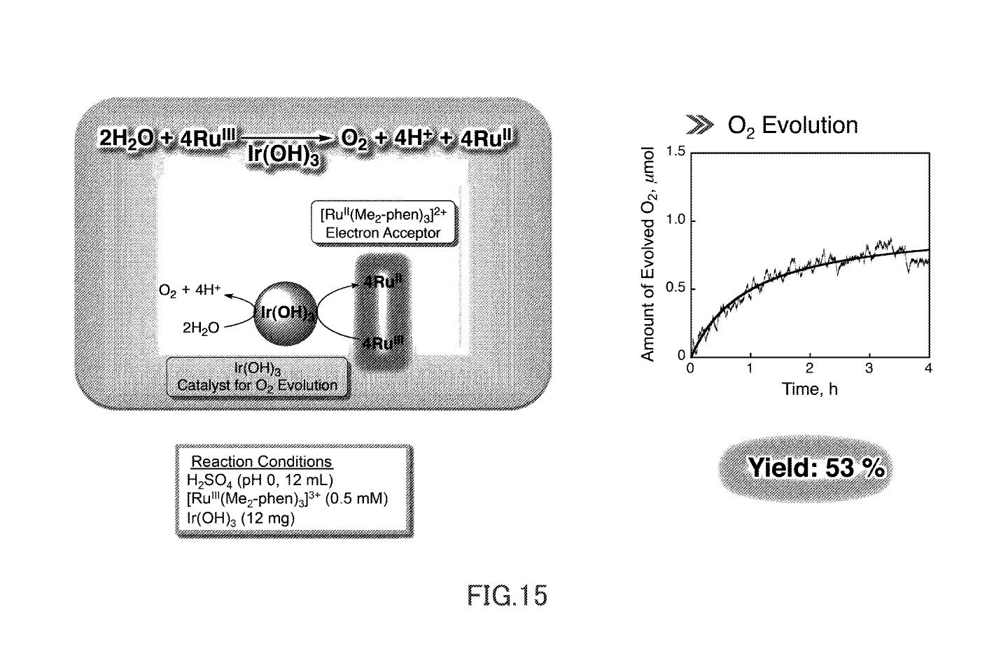

IrOₓ (12 mg) was placed in a cell with two optical windows that has an optical path length of 1 cm and was sealed using a rubber septum in air. Then, an aqueous [Ru^{III}(Me₂-phen)₃]³⁺ solution prepared in air was added to the cell using a syringe to initiate a reaction. Subsequently, the cell was kept still at mom temperature (2981K) without irradiation with light to continue the reaction for 4 hours while quantitatively determining an oxygen concentration of this solution using an oxygen sensor (FOXY Fiber Optic Oxygen Sensor, manufactured by Ocean Optics). A sensor part of the oxygen sensor was enclosed and placed in the solution by causing a wire of the sensor to penetrate the rubber septum. That is, as described above, a reaction system containing water, a water oxidation catalyst (Ira), and a transition metal complex ([Ru^{III}(Me₂-phen)₃]³⁺) as an oxidant was prepared, and oxygen generated with the progress of the reaction was quantitatively determined. The aqueous [Ru^{III}(Me₂-phen)₃]³⁺ solution (0.5 mM H₂SO₄-acidic aqueous solution, pH: 0.12 mL) was prepared as follows. First, sulfate-acidic aqueous [Ru^{II}(Me₂-phen)₃]Cl₂ solution (0.5 mM) (12 mL) with pH 0 was provided and was ice-cooled. A powder (100 mg) of lead dioxide (PbO₂, manufactured by NACALAI TESQUE, INC.) was added to the solution to suspend, and the resultant suspension was stirred for 5 minutes with a stirring bar using a magnetic stirrer while ice-cooling the suspension. Thus, an oxidation reaction of [Ru^{II}(Me₂-phen)₃]Cl₂ by the lead dioxide progressed. This suspension was filtered using a syringe filter (product number: DISMIC-13 PTFE 0.45 μm, model number: HP045AN, manufactured by Toyo Roshi Kaisha Ltd.). The resultant filtrate containing [Ru^{III}(Me₂-phen)₃]³⁺ as it was applied to the reaction as an aqueous [Ru^{III}(Me₂-phen)₃]³⁺ solution. A left figure of FIG. 15 is a schematic view assuming a reaction mechanism occurred in Reference Example 4. As shown in the schematic view of FIG. 15, generation of hydrogen peroxide was not found in Reference Example 4, and generation of oxygen (O₂) by a water oxidation catalyst was only found. The results are shown in a right graph of FIG. 15. In the graph of FIG. 15, the horizontal axis indicates a reaction time (h), and the vertical axis indicates a concentration (μM) of oxygen in the reaction system (reaction solution). As shown in the graph of FIG. 15, the amount of oxygen (O₂) generated reached about 0.8 μmol in 3 to 4 hours of the reaction, and the yield of oxygen (O₂) calculated based on the measurement using the oxygen sensor was 53%.

### Example 6

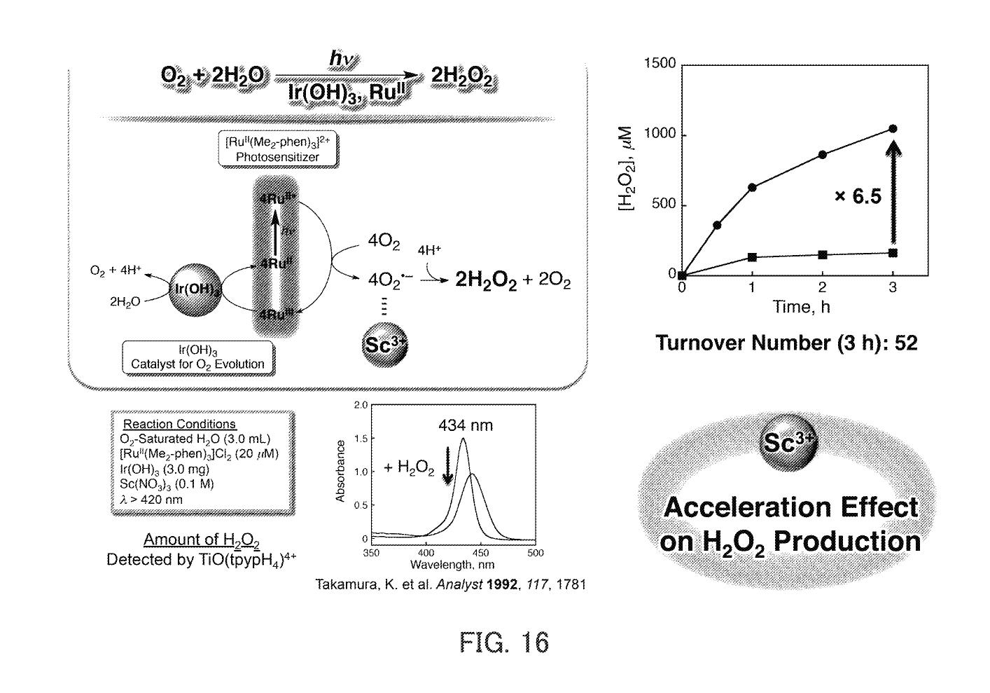

A reaction was performed with irradiation with only light with a wavelength of more than 420 nm (wavelength λ>420 nm) in the same manner as in Example 1 except that a 0.1 M aqueous scandium(III) nitrate (Sc(NO₃)₃) solution was used as a substitute for an aqueous sulfuric acid solution (2 M) in a reaction system in a cell with two optical windows which has an optical path length of 1 cm. The results of the reaction are shown in an upper right graph of FIG. 16 by . In the upper right graph of FIG. 16, the horizontal axis indicates a reaction time GO, and the vertical axis indicates a concentration (μM) of hydrogen peroxide in the reaction system (reaction solution). The quantitative determination of the hydrogen peroxide was performed using a commercially available product, a TiO(tpypH₄)⁴⁺ salt, as in Example 1. A lower middle graph of FIG. 16 shows a change in visible absorption spectrum between TiO(tpypH₄)⁴⁺ and TiO₂(tpypH₄)⁴⁺. In the lower middle graph of FIG. 16, the horizontal axis indicates a wavelength (nm), and the vertical axis indicates an absorbance. An upper left scheme of FIG. 16 is a schematic view assuming a reaction mechanism in the present example (Example 6). Furthermore, the results of a reaction performed in the same manner as in Example 6 except that the reaction was performed in water without addition of scandium(III) nitrate (Sc(NO₃)₃) are shown in the upper right graph of FIG. 16 by ▪.

As shown in the upper right graph of FIG. 16, the TON (based on [Ru^{II}(Me₂-phen)₃]Cl₂) at the reaction time of 3 h was 52 which was 2 times or more the TON in Example 1 and was really high. Moreover, the concentration of hydrogen peroxide at the reaction time of 3 h was 6.5 times the result obtained by performing a reaction in water without addition of scandium(III) nitrate (Sc(NO₃)₃) and was really high. This showed that the Sc³⁺ ion further accelerated the generation of hydrogen peroxide.

### Example 7

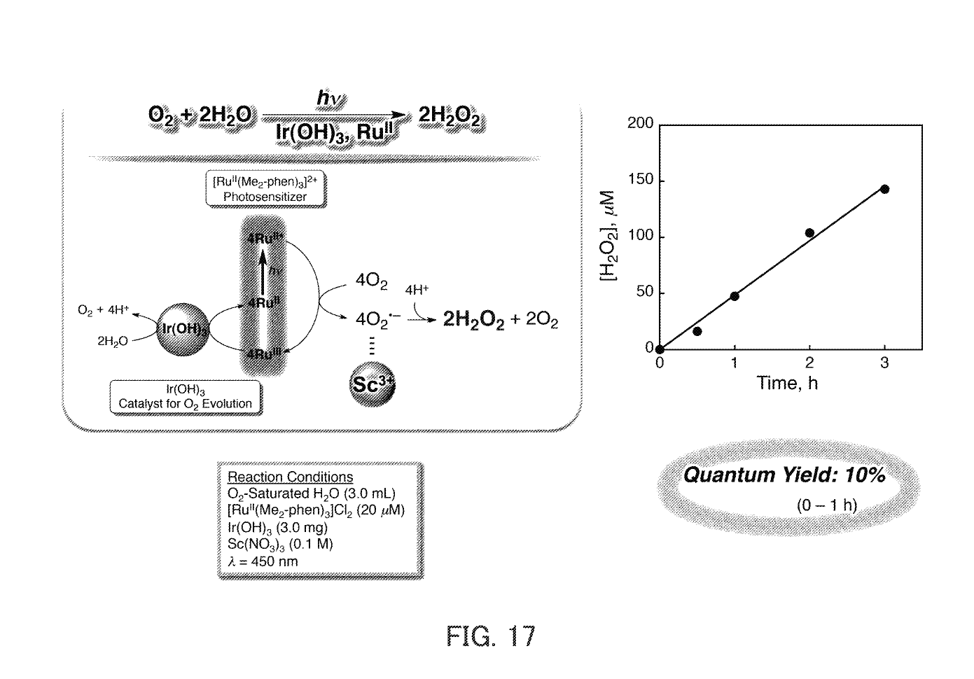

A reaction was performed with irradiation with stationary light with a single wavelength (λ=450 nm) in the same manner as in Example 2 except that 0.1 M scandium(III) nitrate (Sc(NO₃)₃) was further added to a reaction system in a cell with two optical windows which has an optical path length of 1 cm. The results of the reaction are shown in FIG. 17. In a right graph of FIG. 17, the horizontal axis indicates a reaction time (h), and the vertical axis indicates a concentration (μM) of hydrogen peroxide in the reaction system (reaction solution). The quantitative determination of the hydrogen peroxide was performed using a commercially available product, a TiO(tpypH₄)⁴⁺ salt, as in Example 6. A left scheme of FIG. 17 is a schematic view assuming a reaction mechanism in the present example (Example 7).

As shown in the upper right graph of FIG. 17, the quantum yield in the reaction time of 0 to 1 h was 10% and was really high. Moreover, the concentration of hydrogen peroxide at the reaction time of 3 h was about 150 μM and was really high. These values are almost the same as those in Example 2. Although an effect of accelerating generation of hydrogen peroxide by an Sc³⁺ ion was not found, hydrogen peroxide could be obtained with a really high yield as in the Example 2.

### Reference Example 5

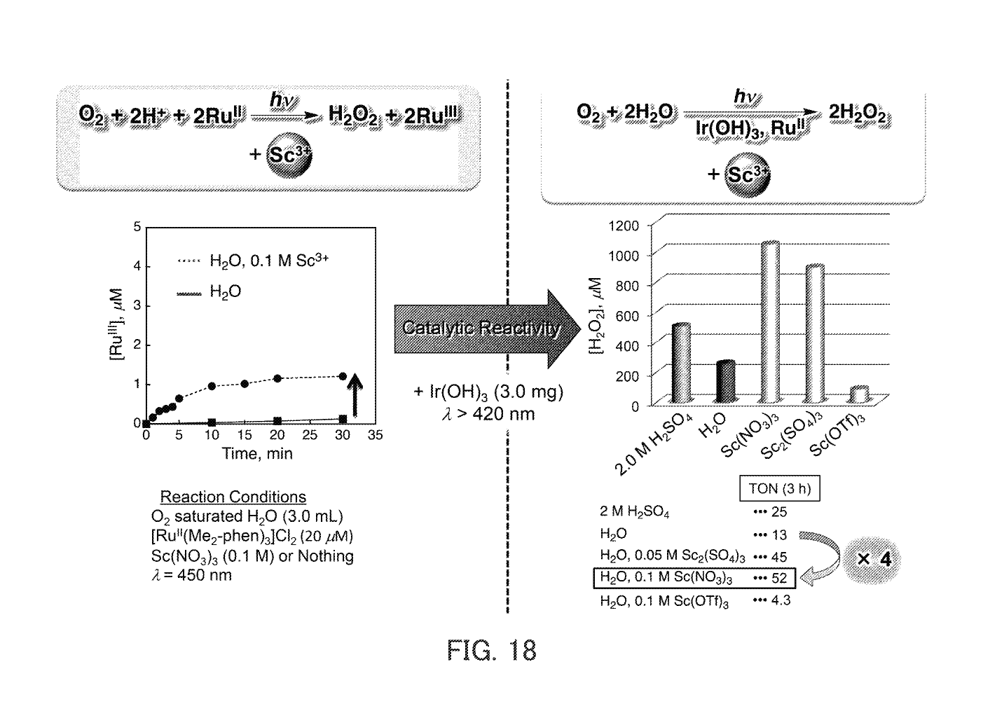

A reaction was performed with irradiation with stationary light with a single wavelength (λ=450 nm) in the same manner as in Example 7 except that IrOₓ was not added to a reaction system in a cell with two optical windows which has an optical path length of 1 cm. The results of the reaction are shown in a left graph of FIG. 18. In the left middle graph of FIG. 18, the horizontal axis indicates a reaction time (minute), and the vertical axis indicates a concentration of Ru³⁺ ion in the reaction system (reaction solution). An upper left scheme of FIG. 18 is a scheme assuming a reaction mechanism in the present reference example (Reference Example 5). As shown in the left middle graph of FIG. 18, by the generation of hydrogen peroxide, Ru²⁺ was oxidized, and Ru³⁺ ion was generated. However, in the present reference example, a water oxidation catalyst was not used, so that generation of oxygen (O₂) by oxidation of water did not occur, and generation of hydrogen peroxide was stopped when oxygen (O₂) in the reaction system ran out.

### Example 8

A reaction was performed with irradiation with only light with a wavelength of more than 420 nm (wavelength λ>420 nm) using a cell with two optical windows which has an optical path length of 1 cm under each of the following conditions (1) to (5). In each of the following conditions (3) to (5), the concentration of scandium(III) ion (Sc³⁺) was the same and adjusted to 0.1 M.

(1) The same conditions as in Example 1
(2) The same conditions as in Example 1 except that water is used as substitute for diluted sulfuric acid
(3) The same conditions as in Example 1 except that water is substituted for diluted sulfuric acid, and 0.1 M scandium(III) nitrate (Sc(NO₃)₃) is added (i.e., the same conditions as in Example 6 except that water is substituted for diluted sulfuric acid)
(4) The same conditions as in (3) above except that 0.05 M scandium(III) sulfate (Sc₂(SO₄)₃) is substituted for 0.1 M scandium(III) nitrate (Sc(NO₃)₃)
(5) The same conditions as in (3) above except that 0.1M scandium(III) trifluoromethane sulfonate (Sc(OTf)₃) is substituted for 0.1 M scandium(III) nitrate (Sc(NO₃)₃)

The results obtained under the conditions (1) to (5) above are shown in a right middle graph of FIG. 18. The results obtained under the conditions (1) to (5) are shown in order starting from the left. The upper right scheme of FIG. 18 is a scheme assuming a reaction mechanism in the case where a scandium(III) is present ((3) to (5) above). “TON (3 h)” shown on the lower right side of FIG. 18 represents TON measured after 3 h from the initiation of the reaction under each of the conditions (1) to (5). As shown in FIG. 18, under each of the conditions (1) to (5), hydrogen peroxide could be produced efficiently with high turnover number TON. Specifically, under each of the conditions (3) using scandium(III) nitrate and the conditions (4) using scandium(III) sulfate, TON which was about two times or more of the TON obtained under the conditions (1) was obtained. Under the conditions (5) using scandium(III) trifluoromethane sulfonate (Sc(OTf)₃), the TON was lower than the TON obtained under the conditions (1). It was assumed that this was because solubility of the ruthenium complex as a photocatalyst was reduced by trifrate ion (OTf).

### Example 9

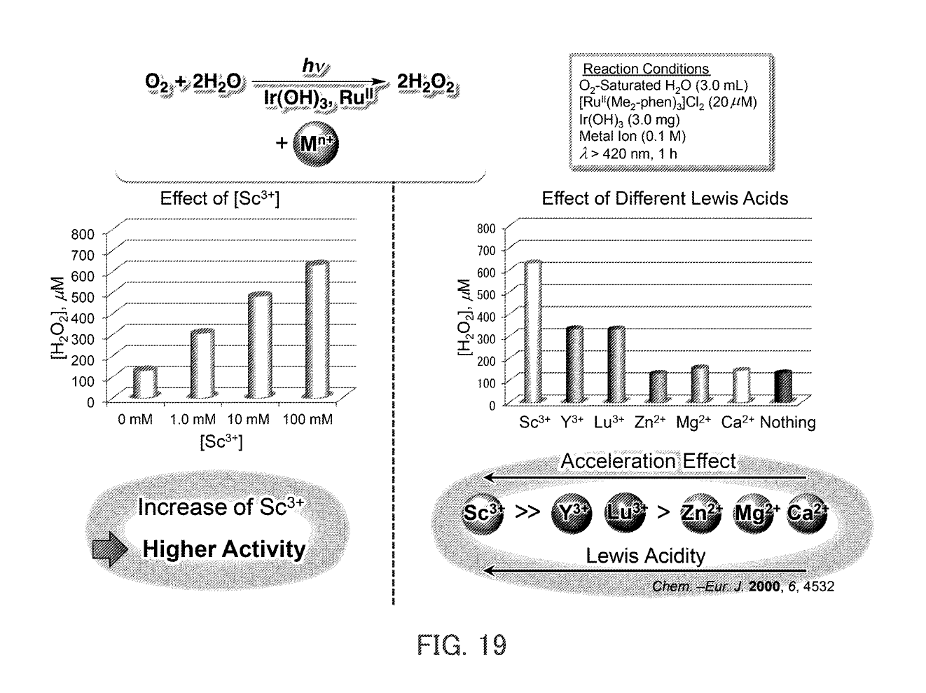

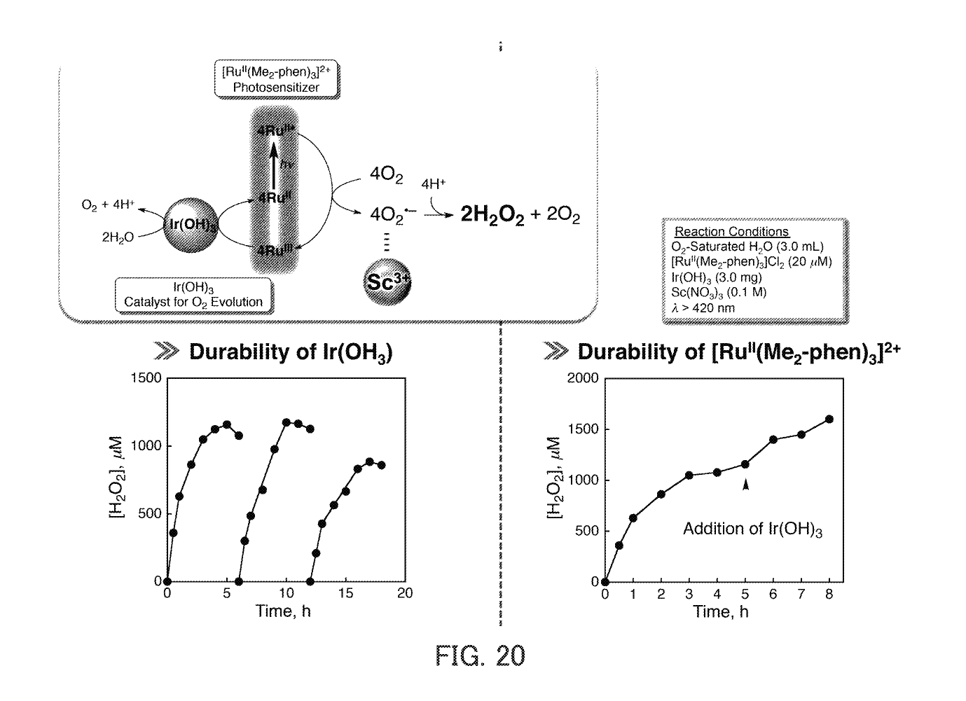

A reaction was performed with irradiation with only light with a wavelength of more than 420 nm (wavelength λ>420 nm) in the same manner as in Example 6 except that the concentration of scandium(III) nitrate (Sc(NO₃)₃) was changed variously from 0 to 100 mM (0.1 M). The results of the reaction are shown in a left graph of FIG. 19. In the left graph of FIG. 19, the horizontal axis indicates a concentration of scandium(III) nitrate (Sc(NO)₃)₃), and the vertical axis indicates a concentration (μM) of hydrogen peroxide in the reaction system after 3 h from the initiation of the reaction. As shown in the left graph of FIG. 19, the amount of hydrogen peroxide generated by a catalystic reaction was approximately proportional to the concentration of scandium ion (scandium nitrate). That is, the higher the concentration of scandium(III) nitrate (Sc(NO₃)₃) was, the higher the activity of the catalyst in the reaction system was, and thus, the large amount of generated hydrogen peroxide was obtained.

### Example 10

A reaction was performed with irradiation with only light with a wavelength of more than 420 nm (wavelength λ>420 nm) in the same manner as in Example 6 except that 0.1 M yttrium(III) nitrate (Y(NO₃)₃), 0.1 M lutetium(III) nitrate (Lu(NO₃)₃), 0.1 M zinc(II) nitrate (Zn(NO₃)₂), or 0.1 M magnesium(II) nitrate (Mg(NO₃)₂) was substituted for 0.1 M scandium(III) nitrate (Sc(NO₃)₃). Moreover, a reaction was performed in the same manner as in Example 6 except that 0.1 M scandium(III) nitrate (Sc(NO₃)₃) was not added to a reaction system (the same conditions as in Example 1). The results of the reaction were compared with those of Example 6. The results are shown in a right graph of FIG. 19. In the right graph of FIG. 19, the vertical axis indicates a concentration (μM) of hydrogen peroxide in the reaction system after 1 h from the initiation of the reaction. An upper scheme of FIG. 19 is a scheme assuming a reaction mechanism in the present example. Moreover, a lower right graph of FIG. 19 is a schematic view showing intensity of Lewis acidity. As shown in the lower right graph of FIG. 19, Lewis acidity of Y³⁺ and Lu³⁺ is intense compared with that of Zn²⁺, Mg²⁺, and Ca²⁺, and Lewis acidity of Sc³⁺ is intense compared with that of Zn²⁺ and Mg²⁺.

As shown in the right graph of FIG. 19, the amount of generation (concentration) of hydrogen peroxide in the case of adding Zn²⁺, Mg²⁺, or Ca²⁺ was almost the same as that in the case of adding anything (Example 1). In contrast, in the case of adding Y³⁺ or Lu³⁺, activity of the catalyst added to the reaction system was accelerated, and thus, the amount (concentration) of hydrogen peroxide generated was increased. As described above, it was determined that the higher the intensity of Lewis acidity of the added metal ion was, the more the activity of the catalyst added to the reaction system was accelerated, and thus, the amount of generation (concentration) of hydrogen peroxide was increased.

### Example 11

A reaction was performed with irradiation with only light with a wavelength of more than 420 nm (wavelength λ>420 nm) in the same manner as in Example 6. The reaction was continued for a long time under these conditions, and durability of IrOₓ (water oxidation catalyst) was determined. The results of the determination are shown in a left graph of FIG. 20. In the left graph of FIG. 20, the horizontal axis indicates a reaction time (h), and the vertical axis indicates a concentration (μM) of hydrogen peroxide in the reaction system at the reaction time corresponding to the horizontal axis. As shown in the left graph of FIG. 20, when [Ru^{II}(Me₂-phen)₃]Cl₂ with the same concentration as an initial concentration was again added to the reaction system to restart the reaction at the time when the concentration of hydrogen peroxide was stopped to be increased by losing activity of [Ru^{II}(Me₂-phen)₃]Cl₂ (6 and 12 hours from the reaction), hydrogen peroxide was generated again. Although the reaction was continued for 18 hours as described above, catalytic activity of IrOₓ was hardly reduced.

### Example 12

A reaction was performed for a long time under the same reaction conditions as in Example 6, and durability of [Ru^{II}(Me₂-phen)₃]Cl₂ as a catalyst was determined. The results of the determination are shown in a right graph of FIG. 20. In the right graph of FIG. 20, the horizontal axis indicates a reaction time (h), and the vertical axis indicates a concentration (μM) of hydrogen peroxide in the reaction system at the reaction time corresponding to the horizontal axis. As shown in the right graph of FIG. 20, the concentration of hydrogen peroxide in the reaction system almost stopped increasing after 4 to 5 hours from the reaction. When the same amount of IrOₓ (water oxidation catalyst) as in an initial introduction amount was added at 5 hours from the reaction, hydrogen peroxide was generated again. As shown in the right graph of FIG. 20, activity of [Ru^{II}(Me₂-phen)₃]Cl₂ as a catalyst was maintained after continuing the reaction for 8 hours or more.

### Example 13

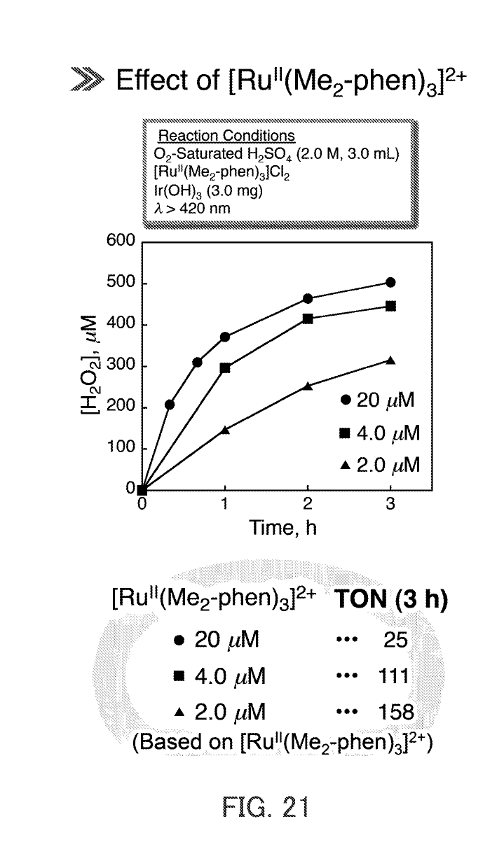

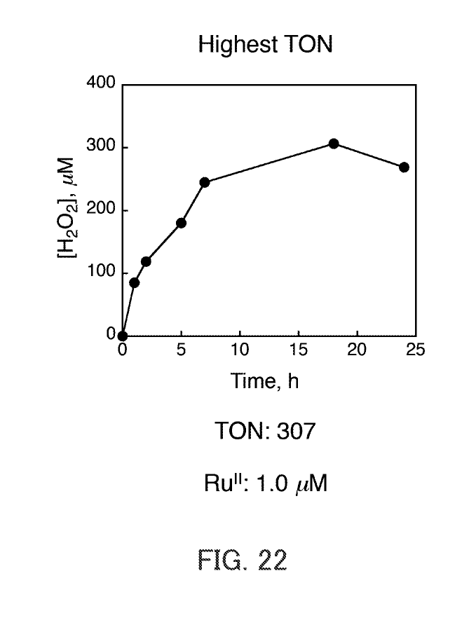

A reaction was performed under the same conditions as in Example 1 except that the concentration of [Ru^{II}(Me₂-phen)₃]Cl₂ was set to be less than 20 μM. The amount of hydrogen peroxide generated and the turnover number (TON) in each of the cases where the concentration of [Ru^{II}(Me₂-phen)₃] was 4.0 μM and 2.0 μM are shown in FIG. 21 together with the amount and the TON in the case where the concentration of [Ru^{II}(Me₂-phen)₃]Cl₂ was 20 μM (Example 1). In a graph of FIG. 21, the horizontal axis indicates a reaction time (time for irradiation with light), and the vertical axis indicates a concentration (μM) of hydrogen peroxide in the reaction system (reaction solution). As shown in FIG. 21, in the case where the concentration of [Ru^{II}(Me₂-phen)₃]Cl₂ was 4.0 μM or 2.0 μM, the concentration (amount of generation) of hydrogen peroxide itself was lower than that in the case where the concentration of [Ru^{II}(Me₂-phen)₃]Cl₂ was 20 μM. However, the TON was dramatically increased compared with the case where the concentration of [Ru^{II}(Me₂-phen)₃]Cl₂ was 20 μM. That is, in the case where the concentration of [Ru^{II}(Me₂-phen)₃]Cl₂ was 4.0 μM, the TON based on the amount of [Ru^{II}(Me₂-phen)₃]Cl₂ was 111, and in the case where the concentration of [Ru^{III}(Me₂-phen)₃]Cl₂ was 2.0 μM, the TON based on the amount of [Ru^{II}(Me₂-phen)₃]Cl₂ was 158. These TONs are two or three times or more of the value (TON=52) in Example 6 in which the concentration of [Ru^{II}(Me₂-phen)₃]Cl₂ was 20 μM, and scandium(III) nitrate was added. That is, it was found that the TON can be drastically improved by optimizing the reaction conditions. Moreover, the amount of generation of hydrogen peroxide and the turnover number (TON) based on the amount of [Ru^{II}(Me₂-phen)₃]Cl₂ in the case where a reaction was performed under the same conditions as described above except that the concentration of [Ru^{II}(Me₂-phen)₃]Cl₂ was s1.0 μM are shown in FIG. 22. In the graph of FIG. 22, the horizontal axis indicates a reaction time (time for irradiation with light), and the vertical axis indicates a concentration (μM) of hydrogen peroxide in the reaction system (reaction solution). As shown in FIG. 22, under these reaction conditions, an outstanding value, TON=307 was obtained.

### INDUSTRIAL APPLICABILITY

As described above, according to the method or the kit for producing hydrogen peroxide according to the present invention, hydrogen peroxide can be produced at low cost. Moreover, the fuel container of the fuel battery according to the present invention contains the transition metal complex and the water oxidation catalyst that are used in the method for producing hydrogen peroxide according to the present invention, and thus, hydrogen peroxide can be utilized as a low-cost fuel. In the present invention, raw materials of hydrogen peroxide are water and oxygen (air), so that a production cost of hydrogen peroxide can be further reduced compared with a conventional method. Therefore, for example, the present invention is useful in a supply of hydrogen peroxide as a fuel of Walter-Antrieb or the like. Even though a fuel engine using hydrogen peroxide as a fuel is a high-performance fuel engine, it has not been widely popularized because of the high cost of hydrogen peroxide. However, according to the present invention, hydrogen peroxide can be supplied at really low cost. Therefore, the utility of these fuel engines can be considerably improved. Thus, hydrogen peroxide can be a novel energy source without depending on petroleum. Moreover, unlike petroleum and the like, hydrogen peroxide does not generate CO₂ even when it is burned. Thus, hydrogen peroxide can be a novel energy source that contributes to a CO₂ reduction. Furthermore, the present invention is not limited to be applied to a fuel engine and is applicable to various technical fields using hydrogen peroxide such as an industrial field, a research field, and a medical field. According to the present invention, as mentioned above, hydrogen peroxide can be obtained from sunlight, water, and air without using a heat source and the like, for example. Therefore, CO₂ can be reduced not only in the step of using hydrogen peroxide but also in the step of producing hydrogen peroxide. Thus, the value of the hydrogen peroxide is really high as a last resort of a novel energy source for reducing CO₂.

1. A method for producing hydrogen peroxide, the method comprising: a hydrogen peroxide generation step of irradiating a reaction system containing water, a water oxidation catalyst, a transition metal complex, and oxygen (O₂) with light to generate hydrogen peroxide.

2. The method according to claim 1, wherein
the transition metal complex is a complex obtained by coordinating an aromatic ligand with a transition metal atom.

3. The method according to claim 2, wherein
the transition metal complex is a complex represented by the following chemical formula (1), 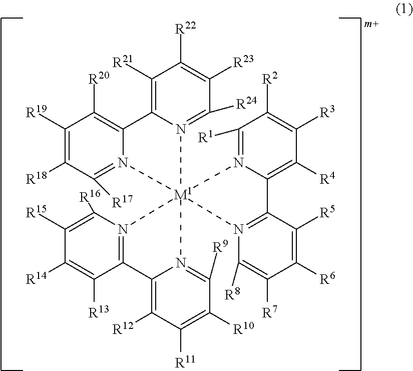
where in the chemical formula (1),
M¹ is a transition metal atom,
R¹ to R²⁴ are each independently a hydrogen atom or any substituent, or
R⁴ and R⁵ may together form a —CH═CH—, that is, R⁴ and R⁵ may, together with a bipyridine ring to which R⁴ and R⁵ are bound, form a phenanthroline ring, where Hs in the —CH═CH— may be each independently replaced by a substituent,
R¹² and R¹³ may together form a —CH═CH—, that is, R¹² and R¹³ may, together with a bipyridine ring to which R¹² and R¹³ are bound, form a phenanthroline ring, where Hs in the —CH═CH— may be each independently replaced by a substituent, and
R²⁰ and R²¹ may together form a —CH═CH—, that is, R²⁰ and R²¹ may, together with a bipyridine ring to which R²° and R²¹ are bound, form a phenanthroline ring, where Hs in the —CH═CH— may be each independently replaced by a substituent, and
m is a positive integer, 0, or a negative integer.

4. The method according to claim 3, wherein in the chemical formula (1), M¹ is ruthenium, osmium, iron, manganese, chromium, cobalt, iridium, or rhodium.

5. The method according to claim 3, wherein in the chemical formula (1),
R¹ to R²⁴ are each independently a hydrogen atom, an alkyl group, an aryl group, a nitro group, a halogen group, a sulfonic acid group (sulfo group), an amino group, an alkylamino group, a carboxylic acid group (carboxy group), a hydroxy group, an alkoxy group, a perfluoroalkyl group, an acyl group, an alkanoyl group, an acyloxy group, or an alkanoyloxy group, or
R⁴ and R⁵ may together form a —CH═CH—, that is, R⁴ and R⁵ may, together with a bipyridine ring to which R⁴ and R⁵ are bound, form a phenanthroline ring, where Hs in the —CH═CH— may be each independently replaced by an alkyl group, an aryl group, a nitro group, a halogen group, a sulfonic acid group (sulfo group), an amino group, an alkylamino group, a carboxylic acid group (carboxy group), a hydroxy group, an alkoxy group, a perfluoroalkyl group, an acyl group, an alkanoyl group, an acyloxy group, or an alkanoyloxy group,
R¹² and R¹³ may together form a —CH═CH—, that is, R¹² and R¹³ may, together with a bipyridine ring to which R¹² and R¹³ are bound, form a phenanthroline ring, where Hs in the —CH═CH— may be each independently replaced by an alkyl group, an aryl group, a nitro group, a halogen group, a sulfonic acid group (sulfo group), an amino group, an alkylamino group, a carboxylic acid group (carboxy group), a hydroxy group, an alkoxy group, a perfluoroalkyl group, an acyl group, an alkanoyl group, an acyloxy group, or an alkanoyloxy group, and
R²⁰ and R²¹ may together form a —CH═CH—, that is, R²⁰ and R²¹ may, together with a bipyridine ring to which R²⁰ and R²¹ are bound, form a phenanthroline ring, where Hs in the —CH═CH— may be each independently replaced by an alkyl group, an aryl group, a nitro group, a halogen group, a sulfonic acid group (sulfo group), an amino group, an alkylamino group, a carboxylic acid group (carboxy group), a hydroxy group, an alkoxy group, a perfluoroalkyl group, an acyl group, an alkanoyl group, an acyloxy group, or an alkanoyloxy group.

6. The method according to claim 3, wherein
the complex represented by the chemical formula (1) is a complex represented by the following chemical formula (2) or (3), 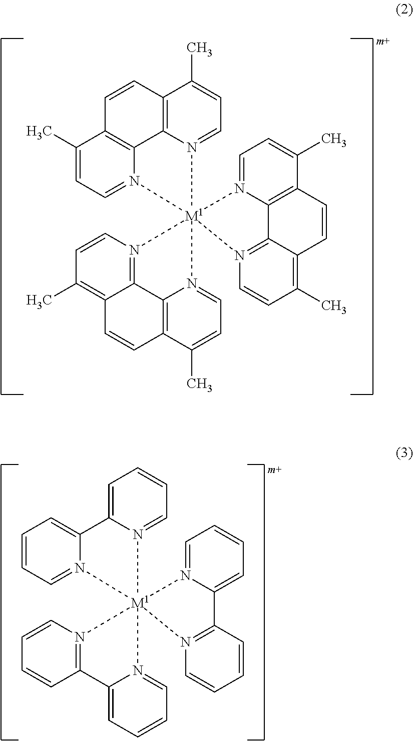
where in the chemical formulae (2) and (3),
M¹ and m are the same as those in the chemical formula (1).

7. The method according to claim 3, wherein
the complex represented by the chemical formula (1) is a complex represented by the following chemical formula (4) or (5),

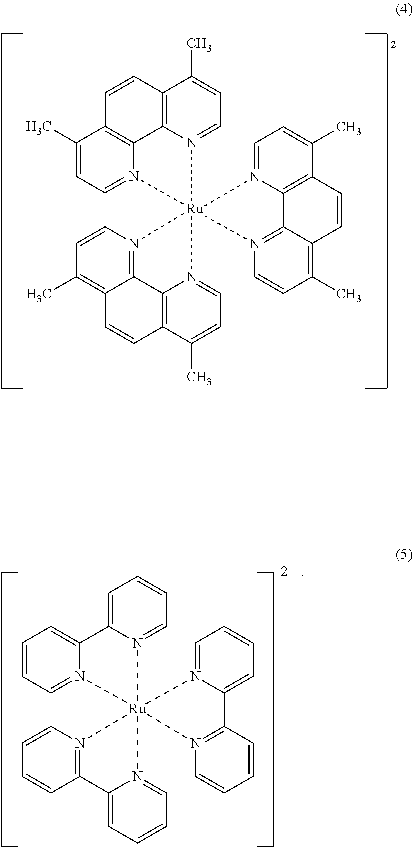

8. The method according to any claim 1, wherein
the water oxidation catalyst is a transition metal oxide or an oxo complex.

9. The method according to claim 1, wherein
the water oxidation catalyst is at least one selected from the group consisting of an oxo complex of ruthenium, an oxo complex of manganese, an oxo complex of iridium, an oxo complex of iron, indium oxide, ruthenium oxide, iridium oxide, tungsten oxide, and vanadic acid bismuth.

10. The method according to claim 1, wherein
the water oxidation catalyst is iridium oxide.

11. The method according to claim 10, wherein
at least 1.5 mg of the iridium oxide can be suspended in 100 mL of water at 25° C.

12. The method according to claim 1, wherein in the hydrogen peroxide generation step, the reaction system further contains Lewis acid.

13. The method according to claim 1, wherein in the hydrogen peroxide generation step, a pH of the reaction system is from −2 to 10.

14. A kit for producing hydrogen peroxide, the kit comprising:
the transition metal complex and the water oxidation catalyst that are used in the method according to claim 1.

15. A fuel battery comprising:
a fuel container; and
a fuel battery cell comprising an anode and an cathode, wherein
the fuel battery generates electricity by an hydrogen peroxide generation reaction from water and oxygen in the fuel container, an oxidation reaction of the hydrogen peroxide on the anode, and a reduction reaction of the hydrogen peroxide on the cathode, and
the fuel container contains the transition metal complex and the water oxidation catalyst that are used in the method according to claim 1.
